(19) United States
(12) Patent Application Publication
(10) Pub. No.: US 2003/0112467 A1
(43) Pub. Date: Jun. 19, 2003

(54) Apparatus and method for multimedia navigation

(76) Inventors: Tim McCollum, Morgan Hill, CA (US); Stephen G. Perlman, Palo Alto, CA (US); Jeff Ma, Redwood City, CA (US); Doug Shannon, Sunnyvale, CA (US); Ain McKendrick, Menlo Park, CA (US); Brian Lanier, Los Gatos, CA (US); Eric Snider, San Jose, CA (US); Greg Hecht, Mountain View, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/029,771

(22) Filed: Dec. 17, 2001

(51) Int. Cl. B41J 1/00; G06F 15/00

(52) U.S. Cl. 358/1.18; 358/1.15

(57) ABSTRACT

A graphical user interface (“GUI”) for navigating through multimedia content is described comprising: a left menu region comprising a first plurality of selectable menu elements, one or more of the first plurality of selectable menu elements having a plurality of sub-elements associated therewith; a selection element to identify one of the first plurality of selectable menu elements; and a right menu region adjacent to the left menu region, the right menu region to display a first plurality of sub-elements associated with an identified one of the first plurality of selectable menu elements.

### BACKGROUND

1. Field of the Invention

This invention relates generally to the field of database management systems. More particularly, the invention relates to an improved system for managing different, incompatible types of broadcast and non-broadcast multimedia content and related information.

2. Description of the Related Art

Electronic program guides have been around for quite some time. For example, Doumit et al. U.S. Pat. No. 4,203,130, filed Jan. 11, 1977, describes a system for displaying program schedule information and other types of data for cable subscribers. The program schedule information is mixed into the transmission signal at the transmission end and is subsequently decoded and displayed on the cable subscriber's television screen.

A more advanced type of electronic program guide is described in Young, et al., U.S. Pat. No. 5,479,266. As illustrated in FIG. 1, each row of the EPG represents a particular channel (e.g., such as HBO 110) and each column represents a particular block of time (e.g., such as the 12:00-12:30 block 130). The programs are represented by a plurality of irregular-shaped cells (e.g., cell 120) which may extend across multiple columns, depending on the length of the represented programs. Using a remote control with directional keys (e.g., up, down, left and right), a user may select a particular program by highlighting the cell corresponding to the desired program and pressing an enter key.

There are various limitations associated with this type of electronic program guide. First, given the vast number of channels available to consumers today, via both digital cable and digital satellite systems, locating a particular program on a particular channel may take a significant amount of time. For example, starting from the state of the EPG shown in FIG. 1, if a user wants to learn what will be broadcast on channel 2 at 9:00 PM, the user must scroll upward through numerous channels to reach channel 2, and then scroll to the right through numerous blocks of time to reach the desired block at 9:00. In addition, while the EPG shown in FIG. 1 may be suitable for selecting a program from a group of broadcast cable/satellite channels, it is not adapted for navigating through other types of multimedia content and related data (e.g., Web pages and other Internet-based content, on-demand streaming video, MP-3 content extracted from compact disks, . . . etc). While some EPG systems allow users to browse program content using certain predefined criteria (e.g., by time, by channel, by program type) these browsing options are severely limited in scope considering the vast amount of programming choices available. Moreover, standard EPG systems currently provide only a limited amount of information on a particular program such as a brief description of the program, a program rating, and possibly the names of one or more actors or other individuals associated with the program.

In addition to the problems associated with the user interface aspects of current EPGs, there are also problems associated with the underlying hardware/software architectures used to support the multimedia systems which implement current EPGs (e.g., such as Tivo™ or ReplayTV™). For example, most of these proprietary architectures were designed from scratch, in a non-modular, inflexible manner. As such, it is difficult (or even impossible) to modify a particular aspect of the EPG or the underlying data which the EPG can process without reinstalling the entire EPG.

Accordingly, what is needed is an improved graphical user interface for navigating through program content. What is also needed is a more efficient, comprehensive, relational navigation system suitable for navigating through the vast amount of multimedia-related information available today and the wide variety of new types of multimedia content available from disparate sources. What is also needed is an improved hardware/software architecture for a multimedia system utilizing an EPG.

### SUMMARY

A system is disclosed comprising: a plurality of disparate databases containing data related to multimedia content and/or Internet content; a plurality of applications to access and process data from the databases; and a node layer comprising a first type of nodes adapted to retrieve data from a first type of database and a second type of nodes to retrieve data from a second type of database, wherein both the first type of nodes and the second type of nodes provide the data to the applications in a consistent data format.

### BRIEF DESCRIPTION OF THE DRAWINGS

A better understanding of the present invention can be obtained from the following detailed description in conjunction with the following drawings, in which:

FIG. 1 illustrates a prior art electronic program guide.

FIG. 2 illustrates one embodiment of a digital media server on which elements of the invention may be executed.

FIG. 3 illustrates an exemplary architecture for a digital media server.

FIGS. 4a-4n illustrate exemplary embodiments of a multimedia navigation interface.

FIGS. 5a-5d illustrate motion of a selection element and a multimedia navigation interface according to one embodiment.

FIGS. 6a-6e illustrate embodiments of a command menu associated with menu items on the multimedia navigation interface.

FIGS. 7a-7d illustrate information regions employed in one embodiment of the invention.

FIGS. 8a-8f illustrate a selection widget employed in one embodiment of the invention.

FIGS. 9a-9c illustrate multimedia playback and recording widgets employed in one embodiment of the invention.

FIG. 10 illustrates a data management interface according to one embodiment of the invention.

FIG. 11 illustrates nodes and services according to one embodiment of the invention.

FIG. 12 illustrates inheritance for a series of exemplary nodes according to one embodiment.

FIG. 13 illustrates a node manager according to one embodiment of the invention.

FIG. 14 illustrates group nodes and media nodes according to one embodiment.

### DETAILED DESCRIPTION

In the following description, for the purposes of explanation, numerous specific details are set forth in order to provide a thorough understanding of the present invention. It will be apparent, however, to one skilled in the art that the invention may be practiced without some of these specific details. In other instances, well-known structures and devices are shown in block diagram form to avoid obscuring the underlying principles of the invention.

### Overview of a Multimedia System

Prior to describing embodiments of the multimedia navigation interface which is the focus of this application, an overview of an exemplary multimedia storage and playback system is provided. It should be noted, however, that many of the specific details of the multimedia system set forth below are not required for implementing the underlying principles of the invention. That is, the multimedia navigation interface may be implemented on virtually any type of multimedia system capable of receiving and processing multimedia content.

Thirty years ago, only a limited number of multimedia devices were available to consumers. These included, for example, radio receivers for playing AM/FM radio, television sets for displaying broadcast video programs, turntables for playing vinyl records, and standard telephones for communicating across long distances. These devices were relatively easy to use and were the only devices capable of playing the media for which they were designed (e.g., a standard LP record could only be played back on a turntable).

Since that time, the digital revolution has produced a seemingly unlimited number of new multimedia devices. For example, audio and video content today may be digitally encoded on compact disks (“CDs”), digital video disks (“DVDs”), MiniDisks™, digital audio/video tapes, and VHS tapes. Moreover, with the proliferation of high speed Internet access through digital subscriber lines (“DSL”) and digital cable systems, consumers are frequently turning to the Internet to retrieve, store and play back audio and video content (e.g., in “MP3” or “MPEG-2” format, respectively).

In addition, the number of multimedia channels over which consumers receive audio, video, and data has increased significantly. Today these include standard broadcast television; digital/analog cable television; various direct-to-home satellite broadcast systems (e.g., DirecTV™, the Dish Network™); Internet service via dial-up, DSL and cable; AM/FM radio; and standard telephone service.

As a result, consumers are burdened with coordinating a variety of incompatible multimedia types and multimedia communication channels. This is not merely burdensome, but also costly and inefficient in that consumers are required to purchase a variety of different stand-alone decoder/playback and encoder/recorder devices, and subscribe to a plurality of incompatible multimedia services (e.g., standard telephone service, digital cable service, DSL Internet service, . . . etc).

Embodiments of a system for storing and processing content from a variety of normally-incompatible media types and media transmission channels is set forth in co-pending application entitled MULTIMEDIA AND COMPUTING SYSTEM, filed Sep. 1, 2000 (Ser. No. 09/653,964), which is assigned to the assignee of the present application and which is incorporated herein by reference.

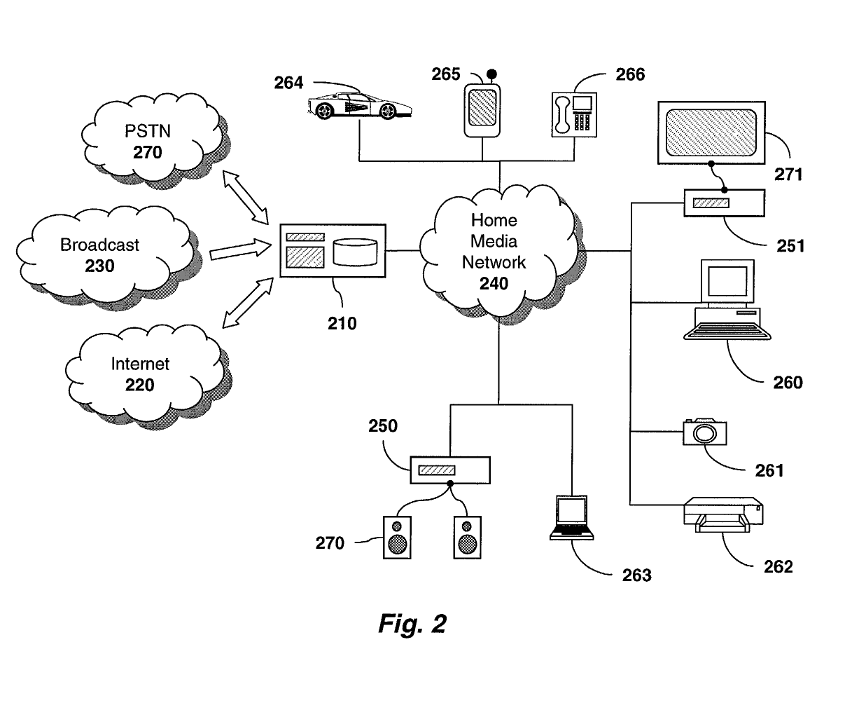

As illustrated in FIG. 2, in one embodiment of this system a digital media server 210 (e.g., a “set-top box”) equipped with a processor and a mass storage device acts as a central repository for storing, decoding and distributing multimedia content and data. More particularly, the digital media server 210 processes multimedia content from Internet communication channels 220 (e.g., DSL, cable Internet), broadcast communication channels 230 (e.g., digital/analog cable, satellite), and/or Public Switched Telephone Network (“PSTN”) communication channels 270 (i.e., standard telephone) to provide a stable, real-time home media network 240 for a plurality of network devices 250-251, 260-266.

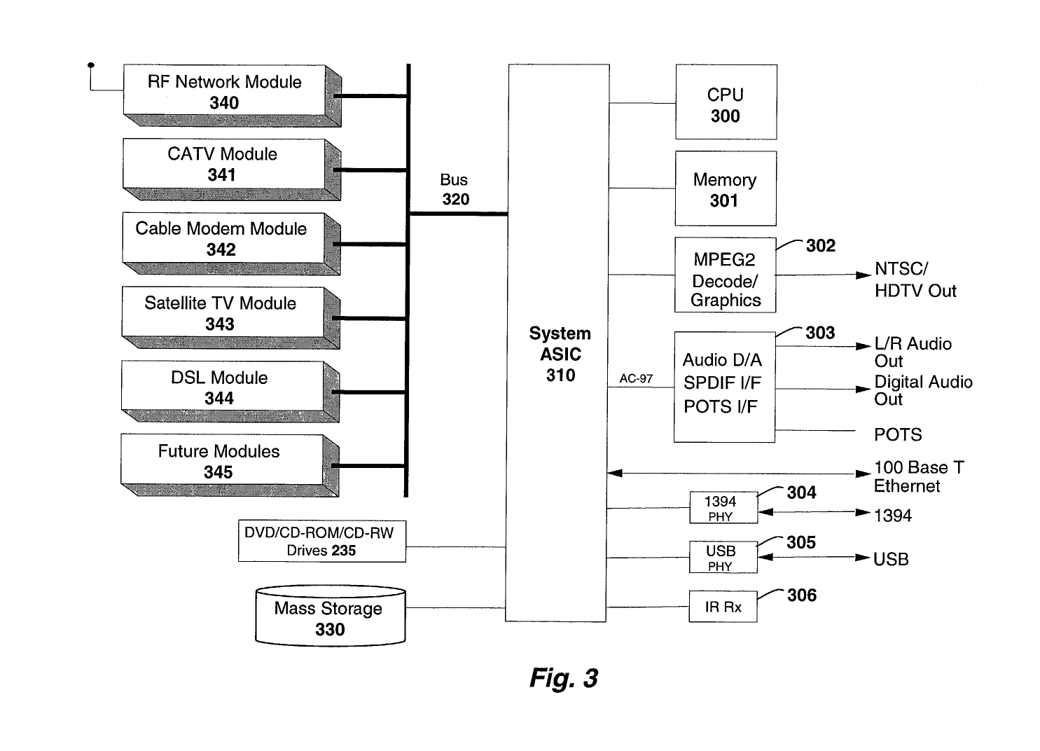

One embodiment of the digital media server 210, illustrated in FIG. 3, comprises a central processing unit 300 capable of processing program code, data and multimedia content stored in main memory 301 and a mass storage device 330 for storing program code, data and multimedia content. In one embodiment, the central processing unit 300 is a Pentium®-class processor such as a Pentium III® operating at a 1 GHz or faster clock frequency. However, various other processors may be employed. The main memory 301 may be a random access memory or any other dynamic storage medium (e.g., SDRAM, DDRAM, RD-RAM, . . . etc). The mass storage device 330 of one embodiment is capable of storing hundreds, or even thousands of hours of multimedia content (e.g., movies, digital audio, . . . etc) as well as other types of digital data (e.g., computer programs, word processing documents, . . . etc). Devices transmit and receive data to/from the mass storage device 330 over a high speed interface such as an enhanced IDE interface with Ultra DMA capabilities or a Small Computer System Interface (“SCSI”). However, various other interfaces may be employed while still complying with the underlying principles of the invention.

An application-specific integrated circuit (“ASIC”) 310 coordinates communication between the various system components and offloads certain designated processing tasks from the CPU. The ASIC 310 may be custom built based on the requirements of the digital media server 210 or may be built using gate arrays, standard cells or programmable logic devices.

Communication modules 340-345 electrically coupled to the digital media server 210 via a system bus 320, allow the digital media server 210 to communicate over different local and remote communication channels. In one embodiment, the system bus 320 is a peripheral component interconnect (“PCI”) bus, although various other bus types may be configured within the digital media server 110 (e.g., ISA, EISA, Micro Channel, VL-bus . . . etc).

In the particular embodiment illustrated in FIG. 3, the communication modules 340-345 electrically coupled to the system bus 320 include an RF network module 340 for communicating over the home media network 240 (i.e., via a wireless RF channel), a cable TV module 341 for receiving broadcast cable channels, a cable modem module 342 for providing Internet access via a cable system (i.e., using the TCP/IP protocol), a satellite TV module 343 for receiving satellite broadcasts, and a DSL module 344 for DSL Internet access. Moreover, a virtually unlimited number of new modules may be added as necessary to support new or existing communication channels/protocols (as indicated by module 345).

Other components within the digital media server 110 architecture include an MPEG-2 decode module 302 (and/or other decode modules such as AC3, MPEG-4, Real Video 8 . . . etc); an audio module 303 comprised of a digital-to-analog converter, a Sony-Philips Digital Interconnect Format (“SP-DIF”) interface and a standard telephony interface for providing digital and analog audio and standard telephone service to external audio/telephony devices; an Ethernet port provided directly the system ASIC 310 (as indicated by the “100 Base-T Ethernet” designation); a Firewire (IEEE 1394) port 304; a Universal Serial Bus (“USB”) port 305; and an infrared port 306. Various other communication interfaces may be configured in the system, either directly on the primary digital media server architecture 210 (e.g., on the media server 110 “motherboard”), or as an add-on module 340-345. Moreover, the communication modules (e.g., 302-306), the CPU 300 and/or the memory 301 may be incorporated within the system ASIC 310, rather than as separate modules as illustrated in FIG. 3.

Embodiments of the digital media server 210 may also be equipped with a DVD drive, CD player, CD Read-Write drive, recordable DVD drive (as described in greater detail below), and/or any other type of portable storage medium 335. In one embodiment, these devices may communicate with the digital media server 210 via an AT Attachment Packet Interface (“ATAPI”), although the type of interface used is not pertinent to the underlying principles of the invention.

Referring again to FIG. 2, numerous digital and analog devices may be configured to communicate with the digital media server 210 over the home media network 240. By way of example, and not limitation, these include personal computers 260, cameras or digital camcorders 261, printers 262, notebook computers 263, automotive audio/video systems 264, cell phones or personal digital assistants 265, standard telephones 265 (including fax machines), home security systems (not shown); and/or home climate control systems (not shown).

Distributed multimedia nodes 250 and 251 illustrated in FIG. 2 provide an interface to the home media network 240 for audio systems 270 (e.g., audio amplifiers and speakers) and/or video systems 271 (e.g., standard television sets, wide screen television sets, high definition television (“HDTV”) sets, or any other device capable of displaying video).

In one embodiment of the invention, the digital media server 201 is capable of concurrently processing and storing multiple broadcast programs transmitted over the broadcast communication channels 230. One such system is described in the co-pending application entitled A SYSTEM AND METHOD FOR PROCESSING MULTIPLE BROADCAST MULTIMEDIA STREAMS, filed Feb. 20, 2001 (Ser. No. 09/789,861) (hereinafter “Multiple Stream Application”) which is assigned to the assignee of the present application and which is incorporated herein by reference.

### Embodiments of a Multimedia Navigation Interface

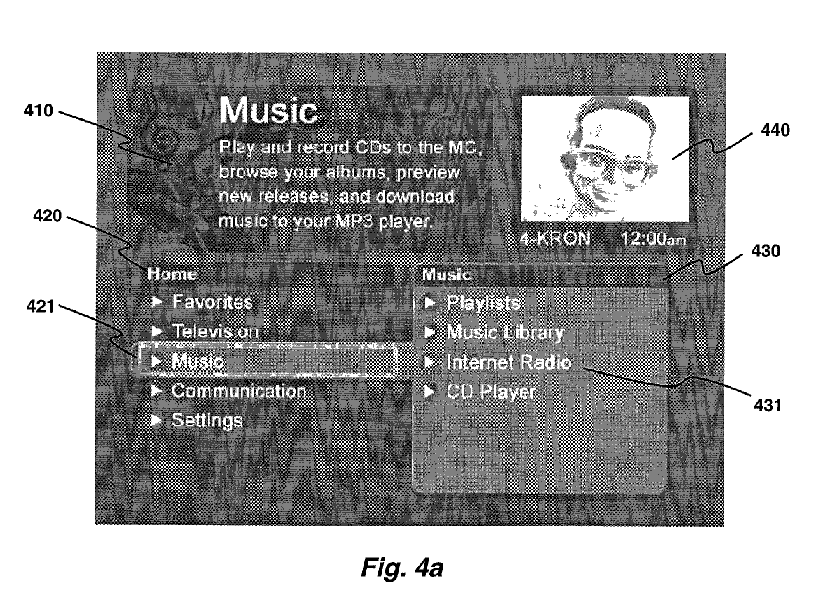

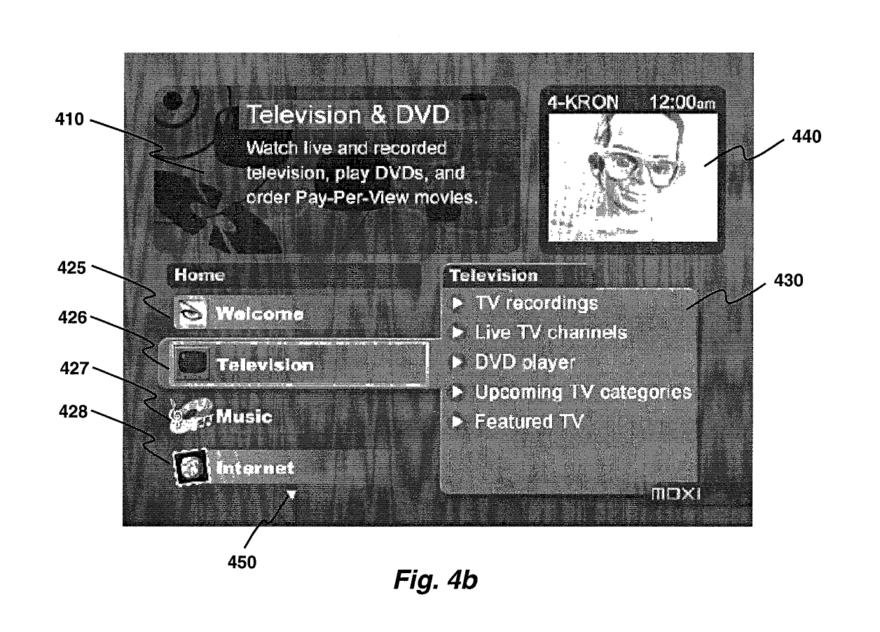

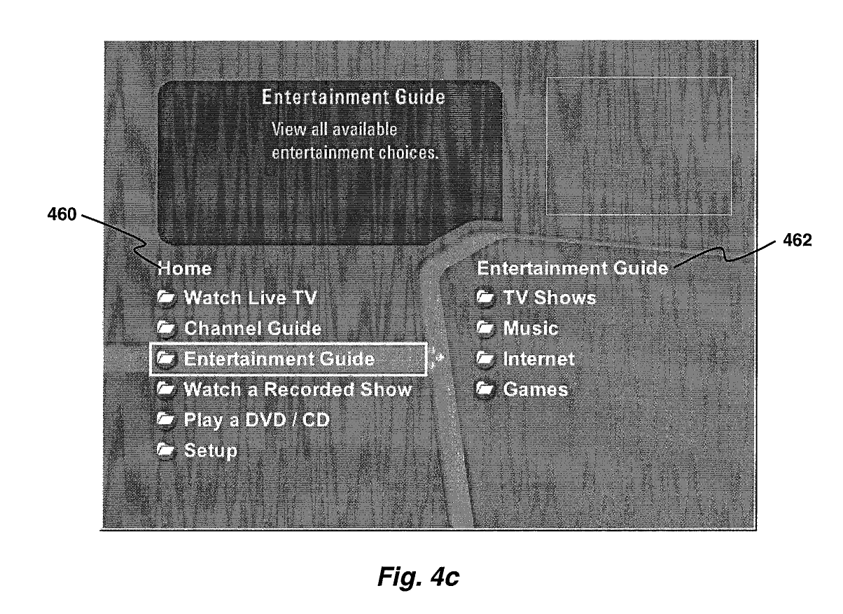

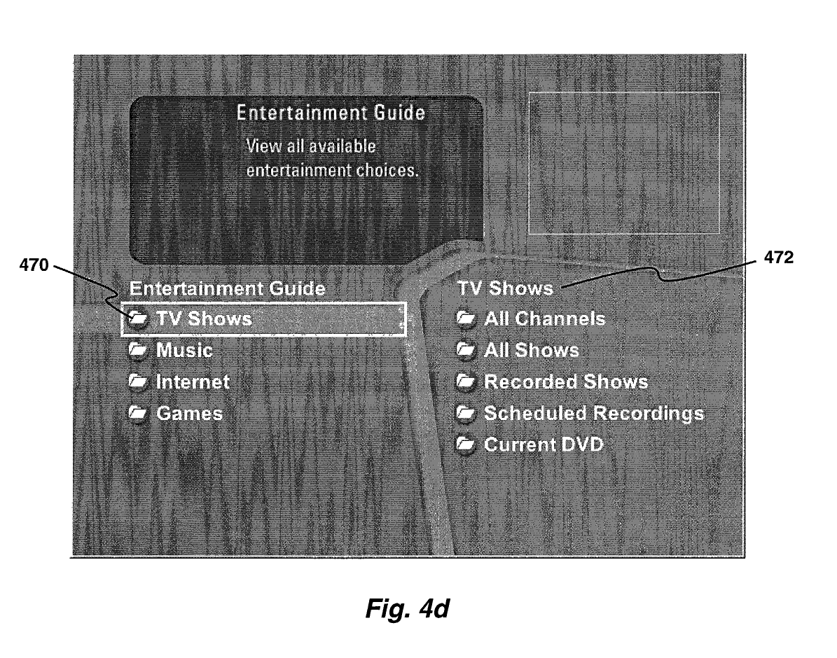

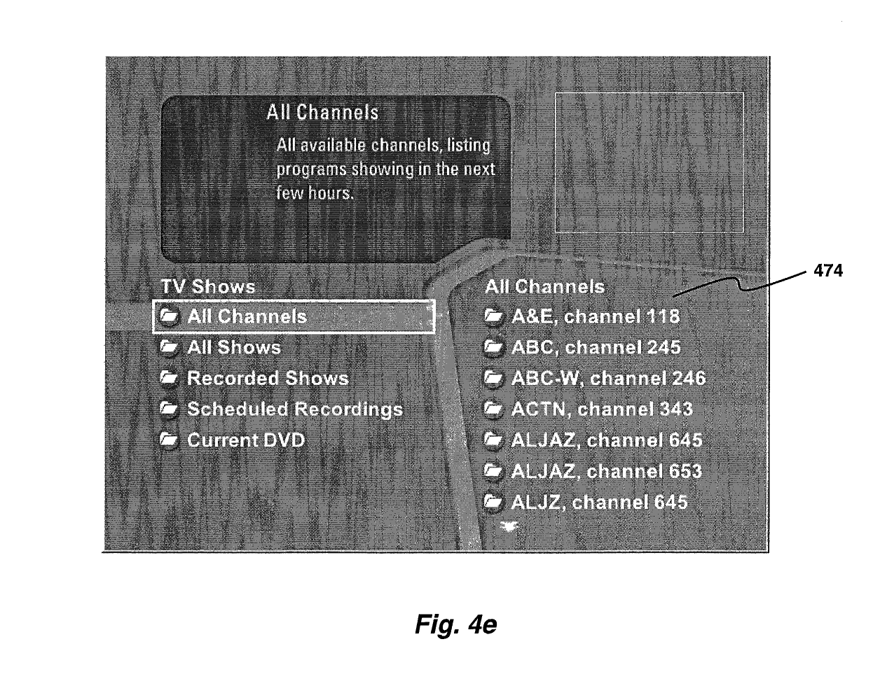

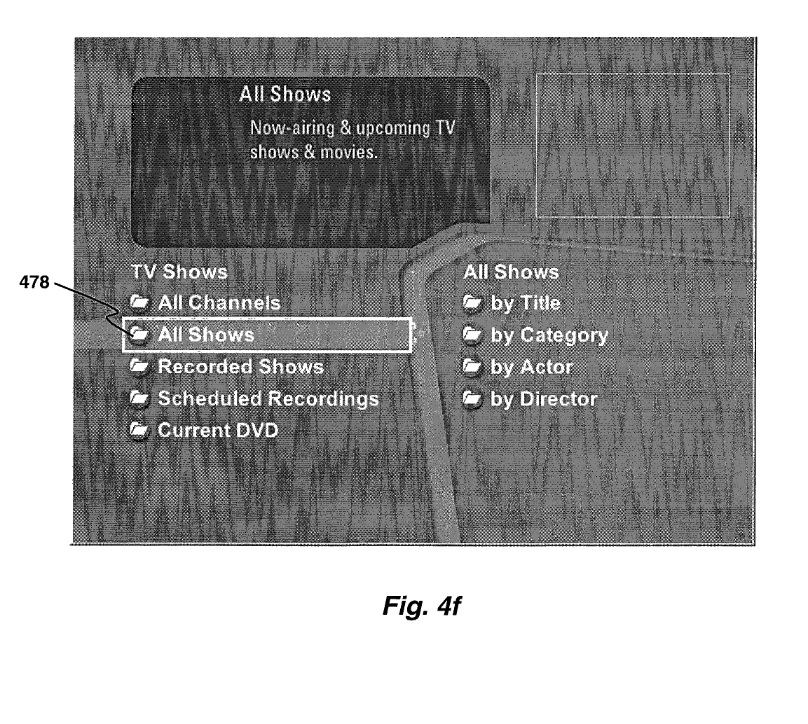

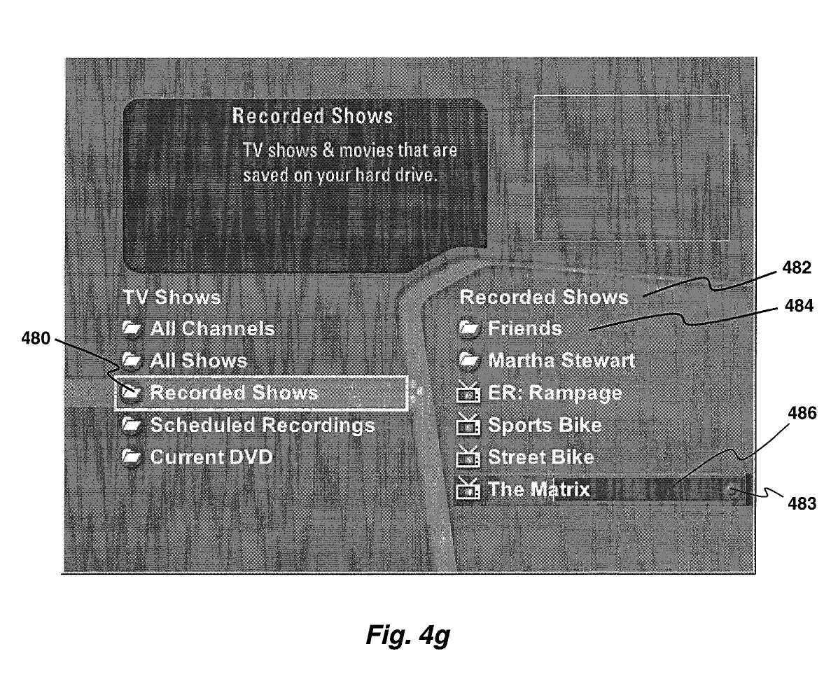

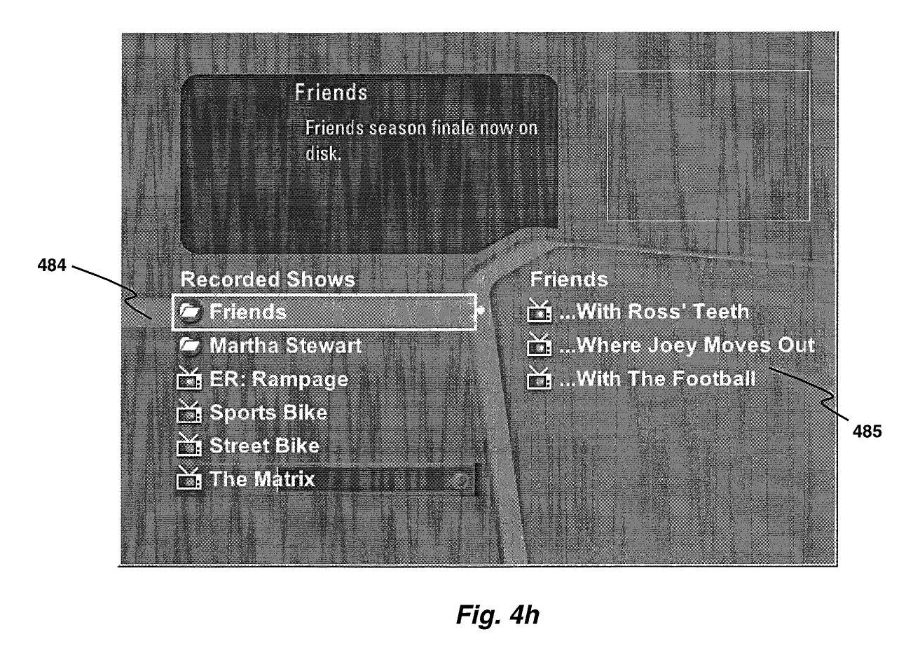

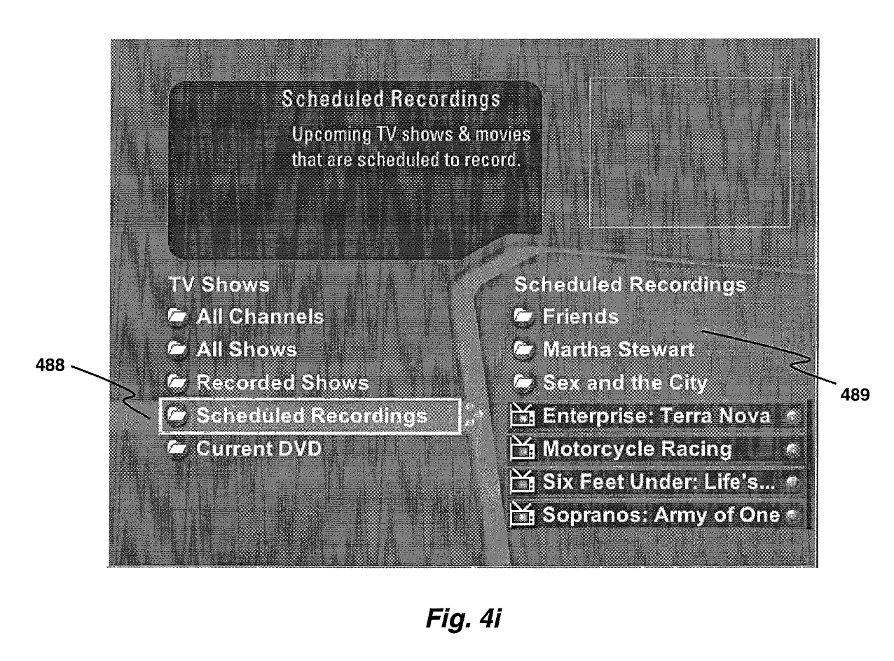

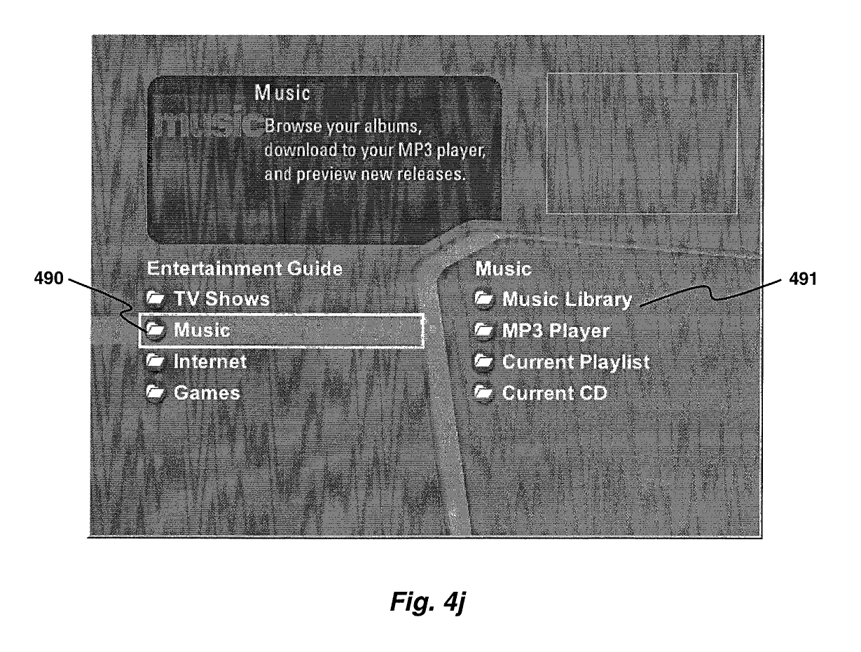

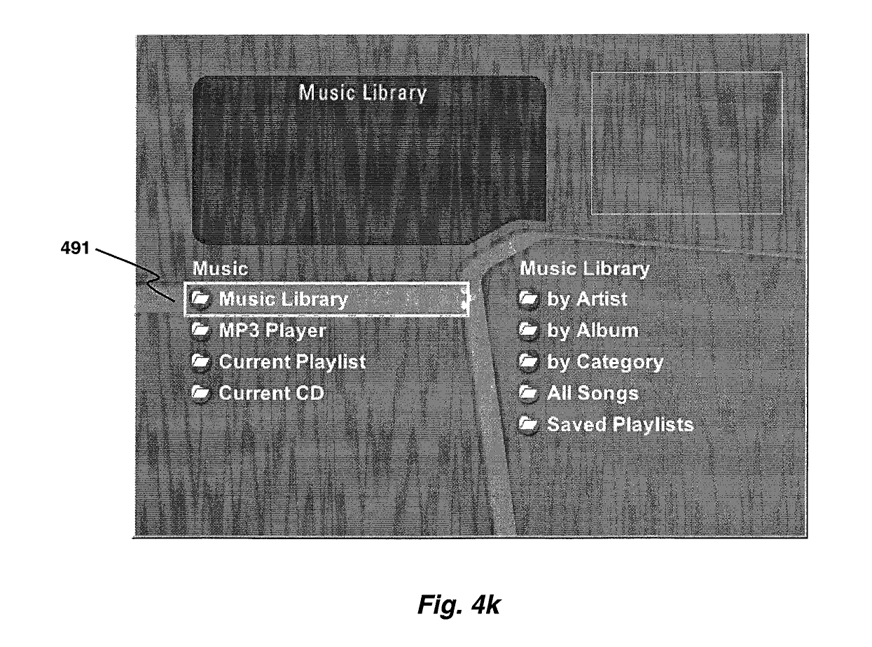

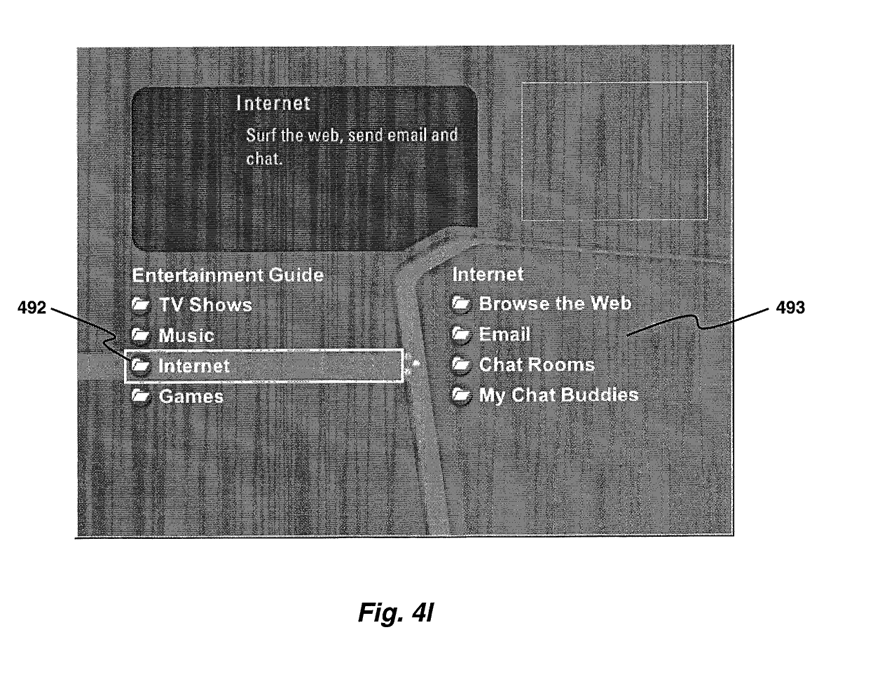

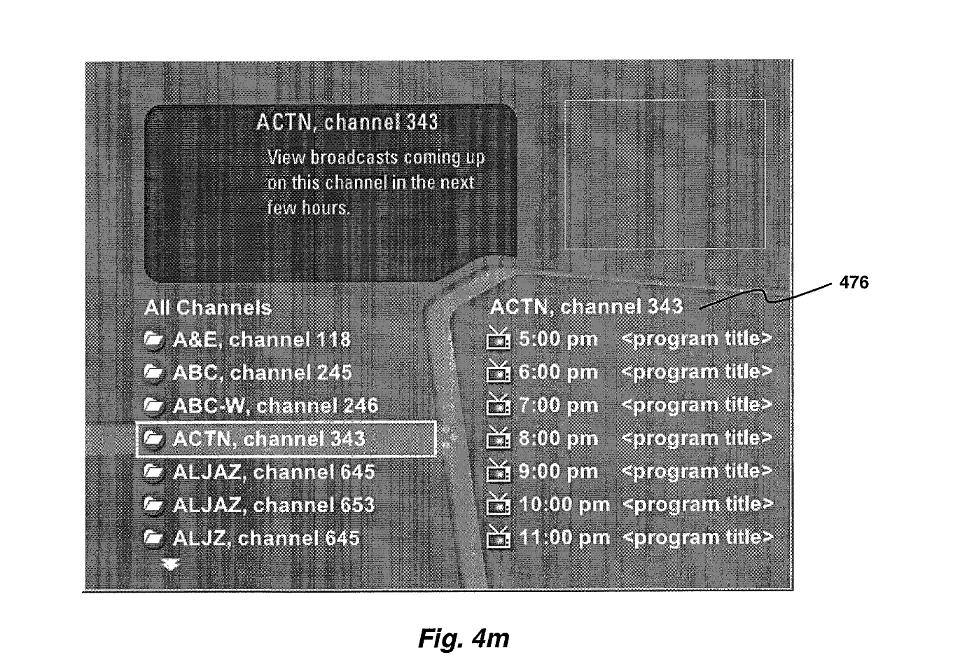

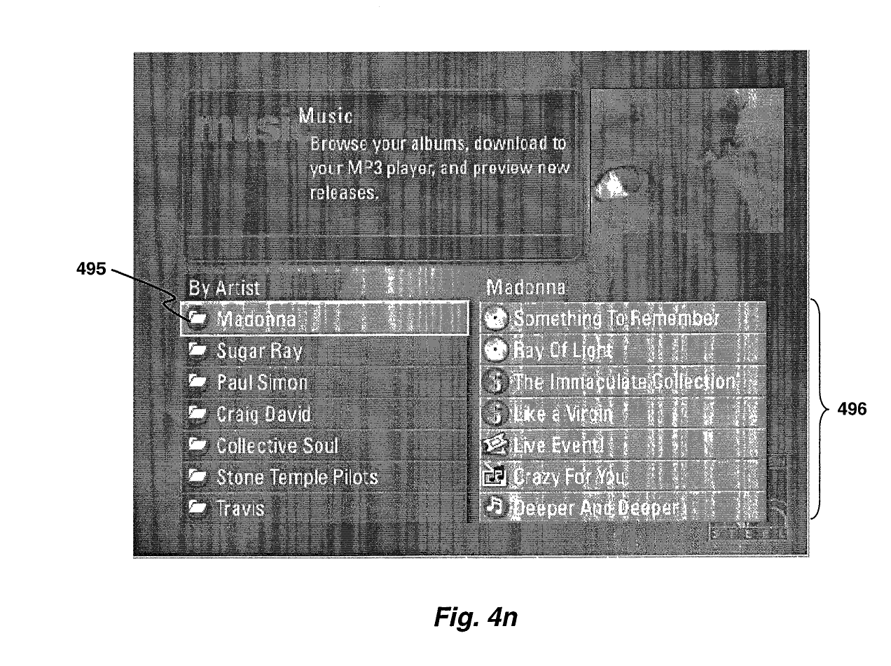

As illustrated in FIG. 4a, one embodiment of a multimedia navigation graphical user interface (hereinafter “multimedia navigation interface”) is comprised of first and second menu regions 420 and 430, respectively, a graphical information region 410, and a video display region 440.

This embodiment of the invention employs a logical menu hierarchy for accessing multimedia content and system functions. More specifically, in one embodiment, the first menu region 420 represents menu items higher up the menu hierarchy from the elements listed in the second menu region 430. As a user moves up and down through the elements in the first menu region 420, the list of selectable choices in the second menu region 430 changes accordingly. For example, in the embodiment shown in FIG. 4a, “music” is highlighted in the first menu region 420 (in this case, the main menu), thereby generating a list of selectable items in the second menu region 430 falling under the “music” heading. This type of menu structure is beneficial, in part, because two levels of the hierarchy are viewable at once, thereby making it easier for a user to locate a particular menu item.

The embodiment shown in FIG. 4a, employs a selection element 421 which may be moved in any direction to select menu items within the menu hierarchy (e.g., via a remote control or other cursor control device). As the selection element is moved from one item to the next, the background color of the selected item may also change, as illustrated, in both the first and second menu regions, 420 and 430, respectively. Various other selection elements and/or selection graphics may be employed while still complying with the underlying principles of the invention.

An information region 410 for displaying context-sensitive information related to the highlighted menu element is also shown in FIG. 4a. For example, with the “Music” menu item highlighted, general information about the audio capabilities of the system is displayed. As will be described in greater detail below, various other types of information may be displayed within the information region 410 including, for example, a description of a highlighted program or movie, the lead actors in the highlighted program/movie, a photo of the CD cover associated with a highlighted musical composition, . . . etc. In addition, various types of graphics and/or animations may be employed within the context-sensitive information region 410. For example, in one embodiment, information and graphics are displayed using vector-based graphics software such as Macromedia Flash.™ In addition, in one embodiment, content providers (e.g., America Online,™ HBO,™ Columbia Records,™ . . . etc) may choose the specific manner in which their own graphics and information are displayed within the information region 410 when a user highlights a relevant menu item. Accordingly, this embodiment provides the content providers with the freedom to describe and/or market their own content in a unique manner.

The supplemental graphics content and/or information contained within the information region 410, as well as information contained within the menu hierarchy itself, may be transmitted over the same communication channel as the underlying multimedia content (e.g., in an MPEG-2 transport stream for cable/satellite providers) and/or via an alternate communication channel (e.g., via a dialup over standard telephone lines or via a high speed Internet connection such as DSL or Cable Modem). The underlying principles of the invention remain the same regardless of how the information/graphics are transmitted.

A video region 440 is also provided in the embodiment illustrated in FIG. 4a. The video region 440 may be used to display video as the user is navigating through the multimedia navigation interface. The video may be from a currently-broadcast show, a recorded show, a DVD currently being played and/or a variety of alternate sources (e.g., streaming video from the Internet). In one embodiment, the video region 440 displays video which was being displayed at the time the user opened the multimedia navigation interface. If audio was being rendered at the time the user selected the interface (e.g., a CD or MP-3 file) then additional information and/or graphics may be displayed within the video region 440. Similarly, if the user was browsing the Internet at the time the multimedia navigation interface was opened, then the current Internet session may be maintained within the video region 440.

FIG. 4b illustrates an embodiment of a home page in which each of the primary headings at the top of the menu hierarchy (i.e., “Welcome” 425, “Television” 426, “Music” 427 and “Internet” 428) are each color coded to represent their respective category. For example, in this embodiment, music or audio content may be represented by a red background, television or other video content may be represented by purple background, and Internet content may be represented by a green background. In one embodiment, all of (or a subset of) the menu items which fall under a particular primary heading (e.g., from the second menu region downward) are color-coded in the same manner as the primary headings themselves, thereby generally identifying the type of content the user is browsing, regardless of how far the user has penetrated down into the menu hierarchy. The particular menu illustrated in FIG. 4b wraps beneath the display as indicated by menu arrow 450. A user may access the remaining menu elements simply by moving the selection element 421 in a downward direction while positioned over the lowest displayed menu item 428.

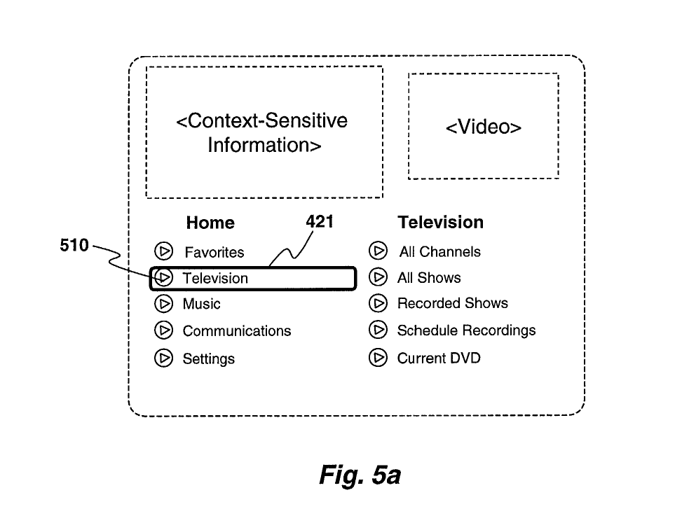

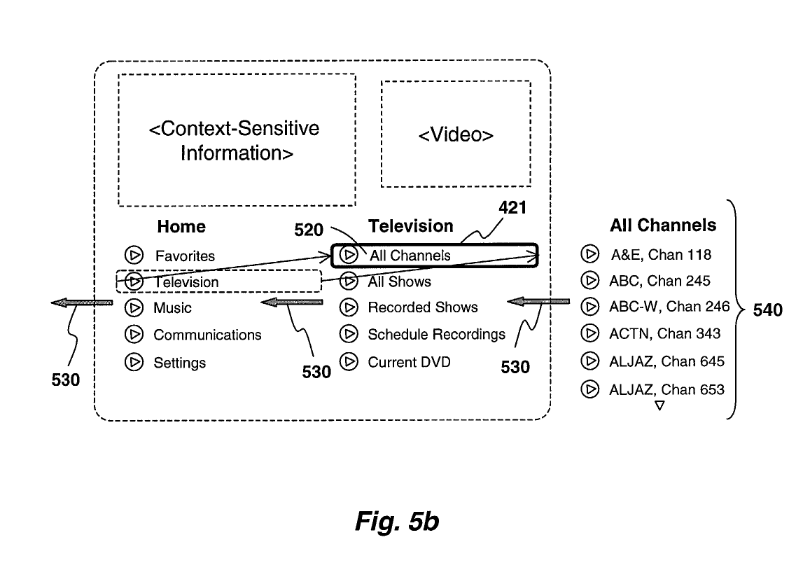

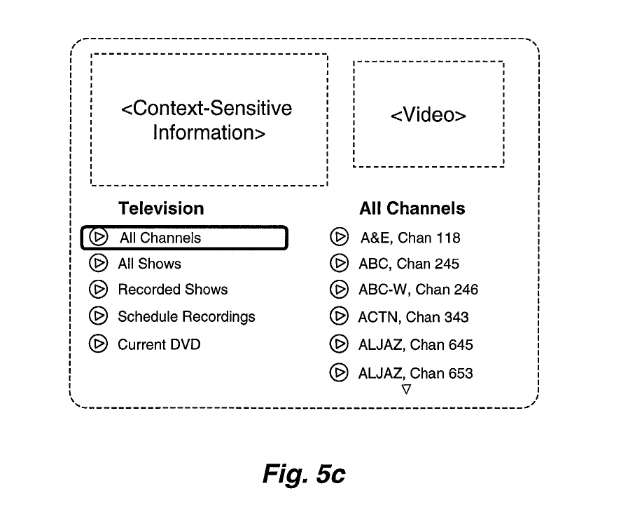

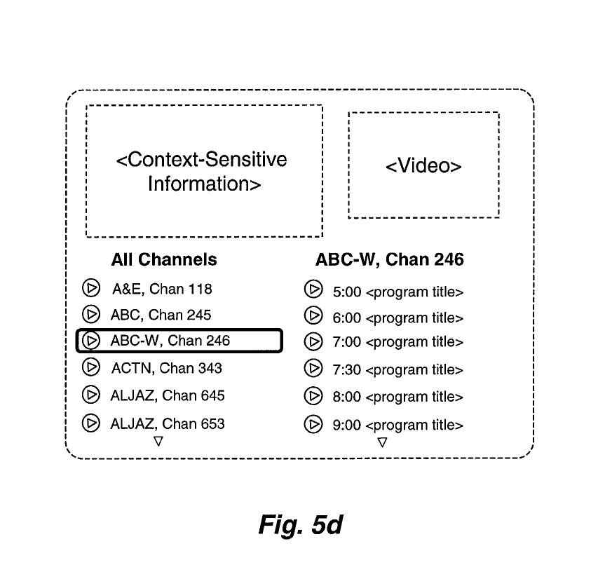

The motion of the selection element 421 and the two menu regions 420 and 430 according to one embodiment of the invention will now be described with respect to FIGS. 5a through 5d. In one embodiment, when a user selects an element from the second menu region 430 by directing the selection element 421 from the first menu region 420 to the right via the remote control (or other cursor control device), the two menu regions 420 and 430 will initially remain stationary as the selection element 421 moves from the left menu region 420 to the right menu region 430. Thus, if the selection element 421 is initially positioned over the “Television” menu item 510 in the left region 420 as illustrated in FIG. 5a, and the user directs the selection element 421 to the right, it will initially move to the right as indicated in FIG. 5b. In the illustrated embodiment, the selection element 421 initially appears over the “All Channels” menu item 520 when directed to the right. It should be noted, however, that the selection element 421 may appear over any of the other menu items in the second region 430 depending on how the system is configured. For example, in one embodiment, the selection element 421 will appear over the menu item last selected by the user. Alternatively, or in addition, in one embodiment, the selection element 421 may appear over the menu item most frequently selected by the user. Various other selection algorithms may be employed to determine where the selection element 421 will initially move within the second menu region 430 while still complying with the underlying principles of the invention.

In one embodiment, once the selection element 421 reaches the menu item 520 in the second menu region 430 as shown in FIG. 5b, both the left and right menu regions, 420 and 430, respectively, move towards the left, as indicated by the motion arrows 530 shown in FIG. 5c. When this motion is complete, as illustrated in FIG. 5d, the first menu region 420 is no longer visible, having moved off of the television screen 550 (or other display) to the left; the second menu region 430 is located in the area previously occupied by the first menu region 420; and a third menu region 540 is in the area previously occupied by the second menu region 430, having moved onto the television screen 550 from the right. This overall effect of this motion is that the selection element attaches to a menu item and drags the entire second menu region 430 to the left. In the illustrated embodiment, the third menu region 540 contains menu items associated with the “All Channels” menu item 520 from the second menu region 420. In one embodiment, the selection element 421 and/or the various menu regions 420, 430, 540, move in a fluid motion (e.g., the element does not simply disappear from the left and reappear on the right, followed by an abrupt rearrangement of the menu regions).

Additional examples of how the multimedia navigation menu structure may be arranged will now be described with respect to FIGS. 4c though 4n. It should be noted, however, that these arrangements are for the purpose of illustration only and are not required for complying with the underlying principles of the invention.

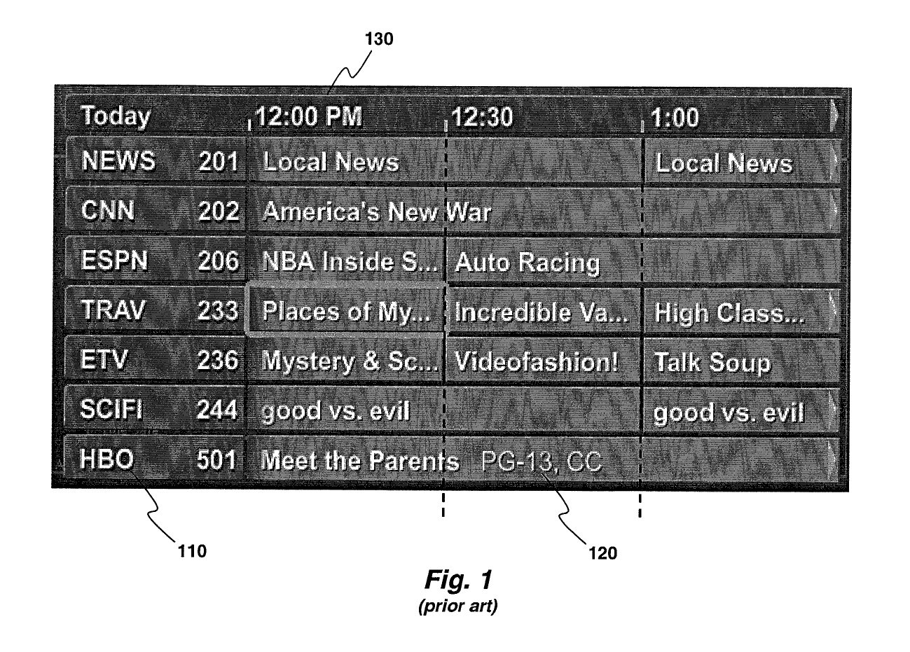

FIG. 4c illustrates an alternate home menu 460 comprised of the following menu items: Watch Live TV, Channel Guide, Entertainment Guide, Watch a Recorded Show, Play a DVD/CD, and Setup. A user may opt to turn on the television (e.g., to browse through channels) by selecting the Watch Live TV item. Alternatively, the user can enter a channel guide (e.g., such as a that illustrated in FIG. 1) by selecting the Channel Guide item. The Entertainment Guide menu item is highlighted in FIG. 4c, exposing several additional menu options in a second menu region 462 (certain of which are described below). The user may watch a show previously recorded (e.g., stored on the mass storage device 330) by selecting the Watch a Recorded Show item or may play a CD/DVD by selecting the Play a DVD/CD menu item. Finally, a user can modify various system settings (e.g., recording quality, menu structure, etc) via a Setup menu item.

In the embodiment shown in FIG. 4d the TV Shows menu item 470 is selected from the Entertainment Guide. As illustrated, the TV Shows heading 470 is comprised of the following subheadings: All Channels, All Shows, Recorded Shows, scheduled Recordings and Current DVD. As shown in FIG. 4e, the All Channels option allows a user to select a particular channel from a list of all channels available on the system. As shown in FIG. 4m, once a user selects a particular channel, a list of programs 476 broadcast on that channel at various times may be displayed. In one embodiment, a user may subsequently jump to a different point in time by scrolling up and down and/or may jump to a new date by selecting a specified button on the remote control device. Thus, the illustrated menu structure allows users to efficiently navigate through a vast number of programs transmitted at different dates/times. In one embodiment, a “New Date” menu item (not shown) is provided in the illustrated menu structure (e.g., at the top of the program title list 476) or on the remote control device to allow the user to locate programming information for a different date.

As illustrated in FIG. 4f, a user may also select the All Shows menu item 478 under the TV Shows heading, thereby generating a list of currently available programs (not shown) organized by title, category, actor or director. As described in the Multiple Stream Application, one embodiment of the invention allows a user to watch any program being broadcast from the beginning (e.g., by buffering the program on the mass storage device 330). As such, in one embodiment, as long as a show appears in the list of current programs, the user will be able to watch the show in its entirety.

As illustrated in FIG. 4g, selecting the Recorded Shows option generates a list of programs 482 recorded on the mass storage device 330 (or other recording medium). In one embodiment, program folders 484 are generated when more than one episode of a recurring program is recorded, either automatically by the system or manually by the end user. As illustrated in FIG. 4h, selecting a program folder 484 provides access to the underlying recorded programs 485. In one embodiment, when a program is in the progress of being recorded, the program entry 486 associated with that program will contain a graphical recording indication. For example, in the embodiment shown in FIG. 4g, a red recording light 483 indicates that the show is being recorded, and the color difference between the left and right areas of the program entry indicates how far recording has progressed. As described above, a user may choose to view the program from the beginning regardless of how far recording has progressed.

As illustrated in FIG. 4i, the Scheduled Recordings heading contains a listing of programs scheduled for recording. As is the case with the Recorded Shows heading, subfolders 489 may be generated when more than a single occurrence of a show is scheduled for recording.

FIGS. 4j through 4m illustrates embodiments of the menu hierarchy falling under the Music heading 490. As illustrated, the Music heading is comprised of the following subheadings 491: Music Library, MP3 Player, Current Playlist, and Current CD.

As illustrated in FIG. 4k, selecting the Music Library option allows a user to identify and play musical content (e.g., MP3 files or other music content stored on the mass storage device 330 or streaming media files located over the Internet) using a variety of categories. Specifically, in the illustrated embodiment, a user may search/play musical content based on the name of the artist, the album, or by a predefined musical category (e.g., Jazz, Classical, Alternative, . . . etc). Alternatively, the user may simply select from a list of all songs or from one or more previously compiled playlists. In one embodiment, a Favorites folder (not shown) is provided which contains the N most frequently played songs and/or CDs. The Favorites folder may be generated automatically by the system, based on the user's past selections, or manually by the user.

In one embodiment of the multimedia navigation interface, users may be required to log in, thereby providing a unique selection of menu items on a user-by-user basis. For example, young children may be provided with only a small subset of all available multimedia content (e.g., only G rated movies and children's programming) whereas parents will be provided with a full range of options. Similarly, each user's preferences (e.g., the “Favorites” folders) may be maintained by the system on a user-by-user basis.

FIG. 41 illustrates an exemplary set of options 493 falling under the Internet heading 492. As mentioned above, one embodiment of a digital media server 210 on which the multimedia navigation interface is implemented includes a connection to the Internet 220. The Internet options include (but are not limited to) browsing through Web pages, checking Email and communicating in Chat Rooms, including the ability to establish a chat buddy list. One embodiment of the invention allows the user to switch input devices from a remote control device to a full-sized keyboard. Alternatively, the user may enter alphanumeric characters via the remote control device as described in greater detail below.

As described above, multimedia content and related information from a variety of sources may be retrieved by the digital media server 210 (or other multimedia apparatus) and stored on a mass storage device 330. As such, one embodiment of the multimedia navigation interface logically organizes this normally-incompatible information and multimedia content. For example, a particular artist may have appeared in several movies and may also have several released audio CDs. The artist may also have a new video published on the Internet (e.g., available for free or on a pay-per-view basis) and may be on a world-wide concert tour. In this case, when a user chooses the artist's name from the multimedia navigation interface, all of the multimedia content and related information may be automatically listed for the user. Thus, as illustrated in FIG. 4n, when “Madonna” is selected from the list of artists, a list 496 is generated including two audio CDs which the user owns, two CDs which the user does not own but which are available for purchase (e.g., either streamed over a network or from a CD vendor/publisher), tickets for an upcoming concert, a new music video, and an audio single. Of course, the generated list may include various other types of multimedia content and information depending on the artist and on the multimedia content owned/preferred by the user (e.g., a movie in which Madonna stars may also be displayed if the user previously purchased the movie or if the movie is available for purchase).

One obvious benefit to the media navigation interface illustrated in FIGS. 4a to 4n is that multiple simultaneous user applications are supported. For example, a user may play a game or search through the media databases while watching a TV program in the video region 440 of the interface. Similarly, the user may browse the internet and respond to an on screen widget displaying and instant message from a friend.

In addition, it will be appreciated that, using a two menu paradigm as described above, allows users to view and operate on TV shows and movies that are both recorded and currently airing. For example, the left menu may show the current channel or category of show; as the user scrolls up and down in the left hand menu, the right hand menu displays the shows, both recorded and currently airing, that are available on that channel (or in that category). In addition, in one embodiment, the user is provided with the ability to filter and select a show based on the time frame that is most relevant to them (available now, available with the next 2 hours, available in the next 4 hours, the next day, next week . . . etc).

In one embodiment, a menu of context-sensitive commands associated with any menu item may be accessed simply by hitting a specified button (e.g., a “command” button on the remote control) while the menu item is highlighted. In addition, a menu of context-sensitive commands may appear automatically each time the user reaches an entry at the end of the menu hierarchy (i.e., where there are no sub-entries corresponding to the entry).

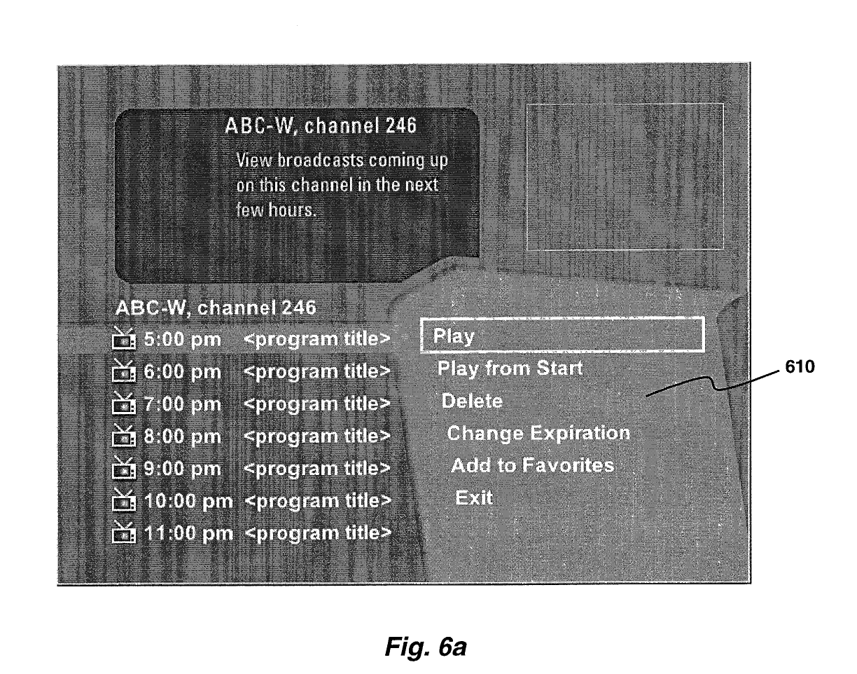

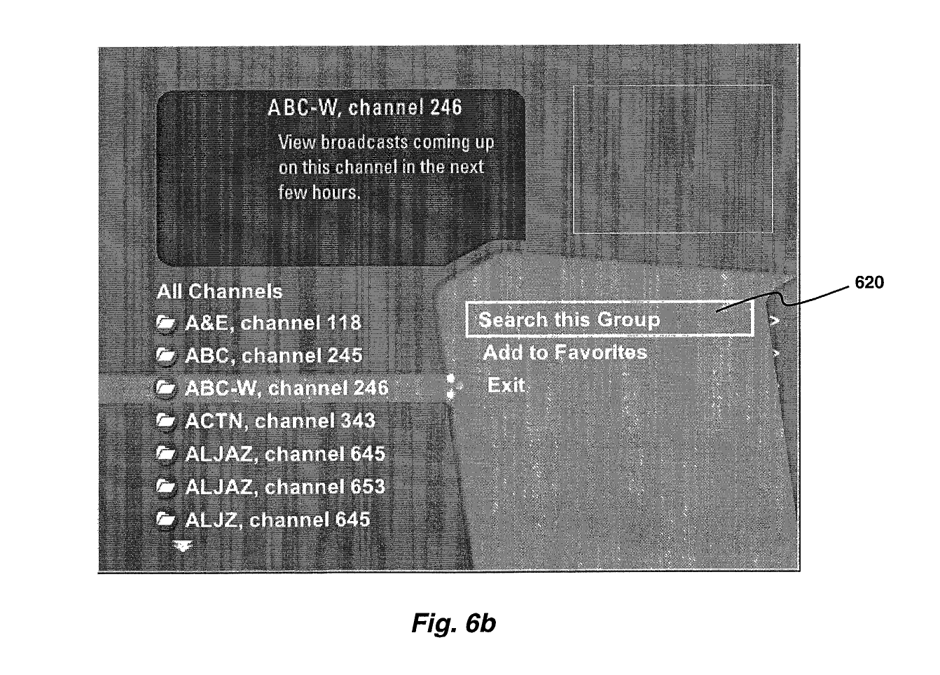

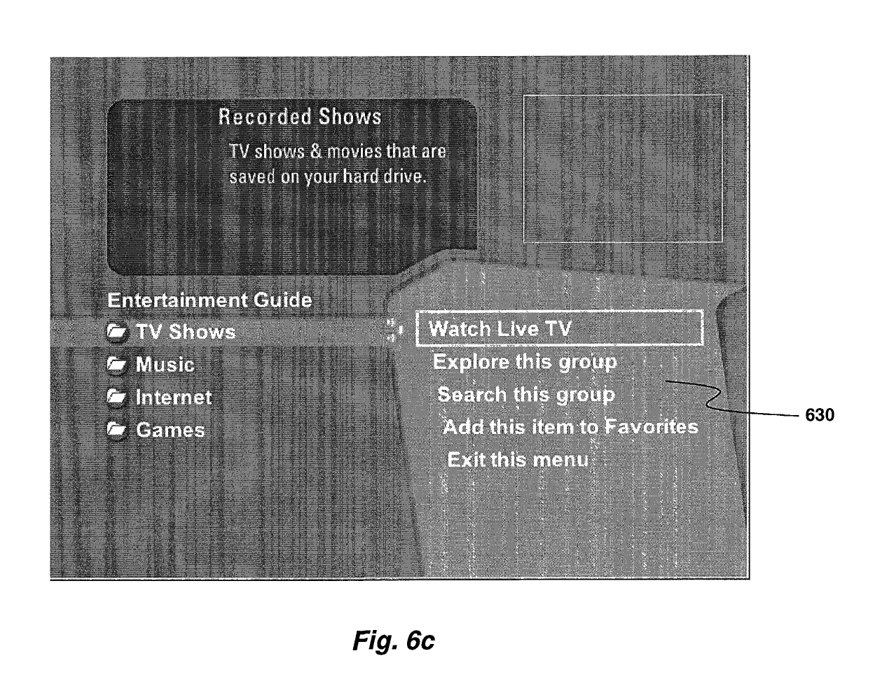

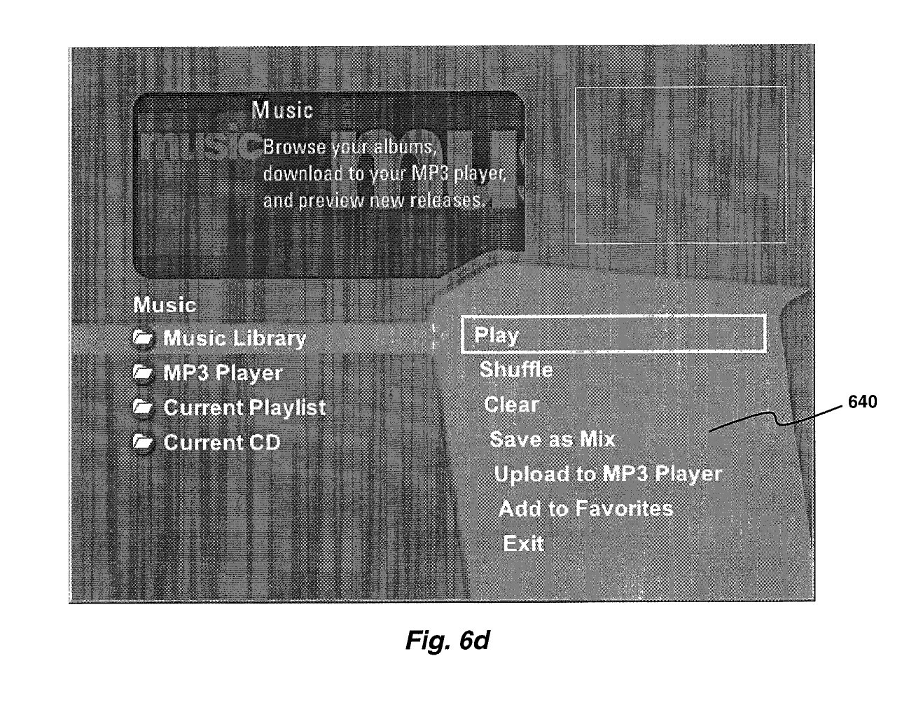

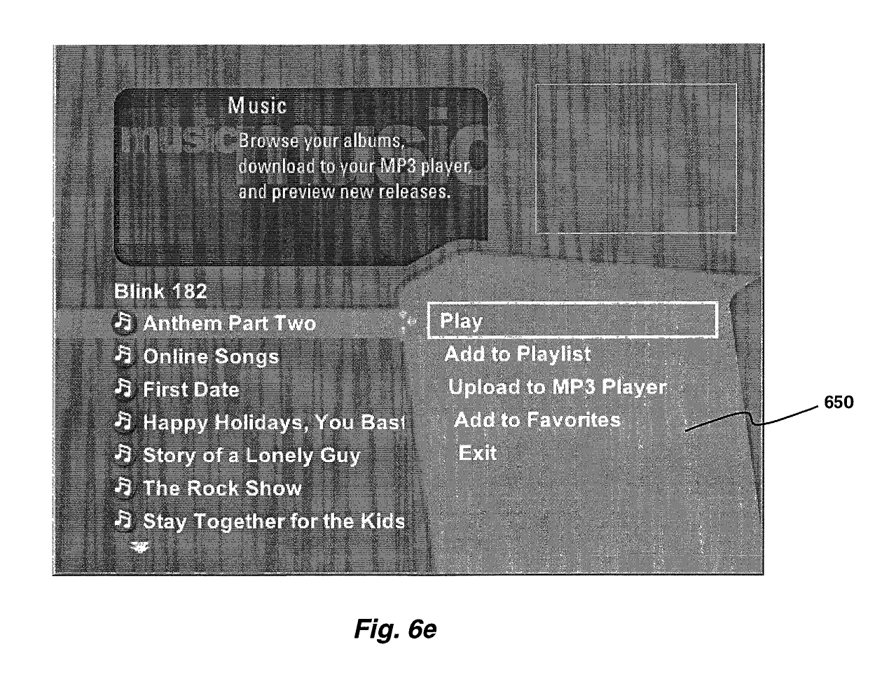

FIG. 6a illustrates one embodiment of a command menu 610 associated with a particular program broadcast on a particular channel (e.g., accessed through the All Channels heading described above). The commands included in the command menu 610 include both Play, to display the program as it is currently being broadcast, and Play From Start, to play the program in its entirety. As described above, one embodiment of the digital media server 210 allows users to watch any program currently being broadcast from the beginning (e.g., by buffering the program on the mass storage device 330).

In addition, the command menu 610 includes a Delete command to delete any portion of the program currently stored on the mass storage device 330, and a Change Expiration command to change the time at which the buffered program will be erased. For example, if a user decides to view the program several hours after the program broadcast is scheduled to complete, the user may indicate that the program should be stored for a longer period of time (e.g., 24 hours) or for an indefinite period of time. The program may then appear in the Recorded Shows folder 480 described above. Finally, the user may choose to add the program to his Favorites group and/or Exit from the command menu 610.

An additional command menu item entitled Search This Group 620 is illustrated in FIG. 6b. In one embodiment, this item will allow a user to search for a specific menu item and/or multimedia file by entering alphanumeric characters associated with the menu item or multimedia file. The search may be limited to the scope of the highlighted menu item. For example, in the context shown in FIG. 6b, the search may be limited to all programs broadcast on Channel 246 (ABC-W). Alternatively, or in addition, the user may choose to search the entire digital media server 210 (i.e., regardless of the particular menu item highlighted). In one specific embodiment, searches may be conducted using one or more of the data selection/filtering techniques described in the copending application entitled APPARATUS AND METHOD FOR SELECTING DATA, filed Mar. 26, 2001 (Ser. No. 09/818,075), which is assigned to the assignee of the present application and which is incorporated herein by reference. In one embodiment, search options are provided from every menu item within the menu hierarchy.

Thus, two general types of user navigation are described (i.e., browsing through menus, or text entry to locate a specific, well defined target), which are effectively merged into the navigation interface. For example the user can browse through menus like “Music” followed by “Artists,” and then choose an action to filter the current list. In one embodiment, this brings up the filtering control (e.g., such as that described in the Apparatus and Method for Selecting Data application mentioned above) and the user can use text entry to further narrow the list and then begin browsing again into the reduced list. Conversely, the user can start out by launching the selection/filtering widget and entering a text string that brings up a list of choices. The user can then immediately start browsing that self-defined list of choices.

FIG. 6c illustrates another embodiment of a command menu 630 associated with the TV Shows menu item which includes a Watch Live TV option, allowing the user to jump to live television. Other options include the ability to explore or search the TV Shows group, to add the group to a Favorites folder or to exit the command menu.

FIG. 6d illustrates an embodiment of a command menu 640 associated with the Music Library menu item. This command menu 640 allows the user to play the entire music library, either in order or shuffled. It also provides an option for saving the current playlist as a mix and clearing the current playlist. In addition, the Upload to MP3 Player option allows the user to upload the current playlist to the user's MP3 player. FIG. 6e illustrates a similar command menu 650 associated with a single music track.

Various alternate command menu items may be associated with menu elements. These may include, for example, standard commands such as Copy, Cut, Paste and Delete, and a virtually unlimited number of context-specific commands (e.g., record this showing, record all showings, view upcoming showings, find similar shows, . . . etc). In short, the underlying principles of the invention are not limited to any specific set of command menu items.

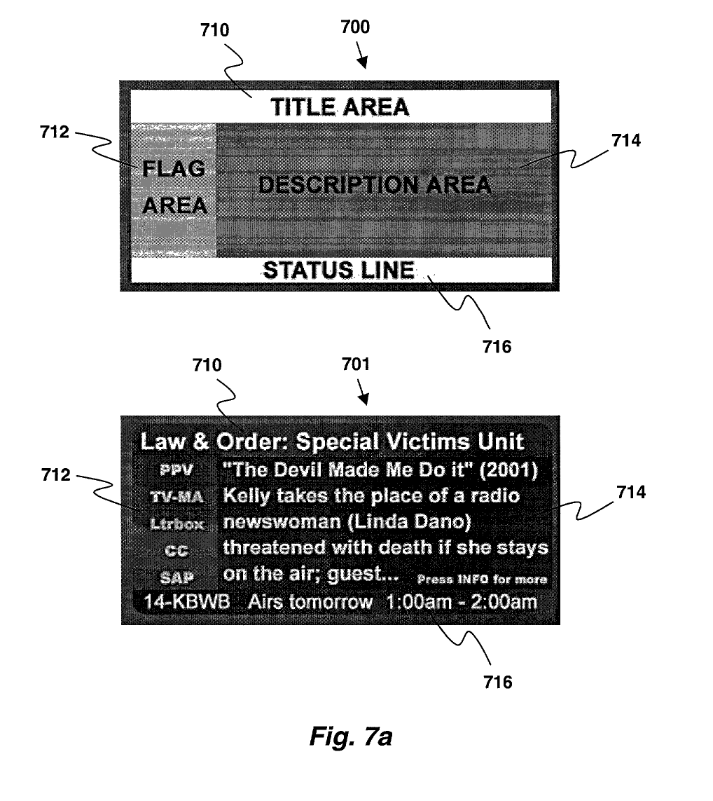

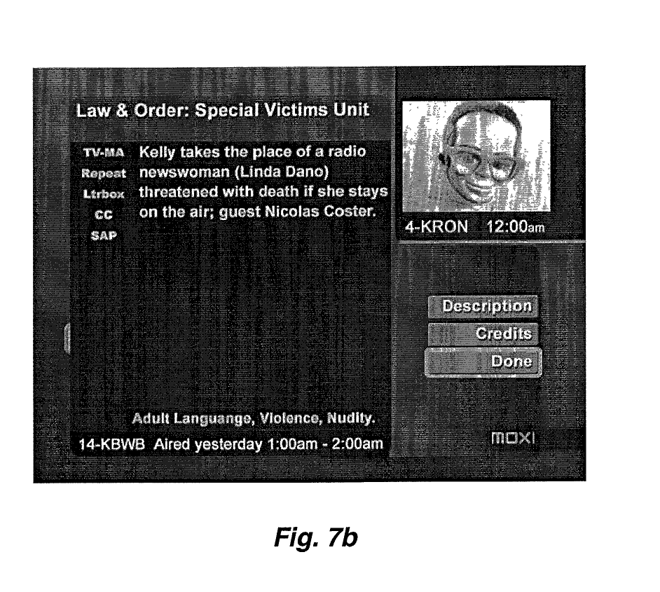

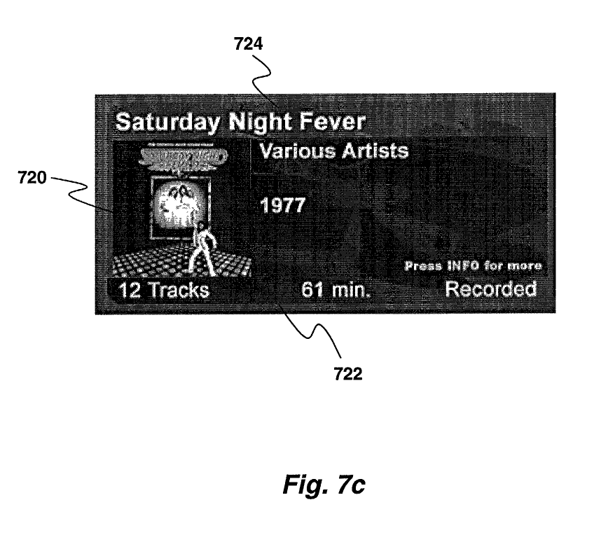

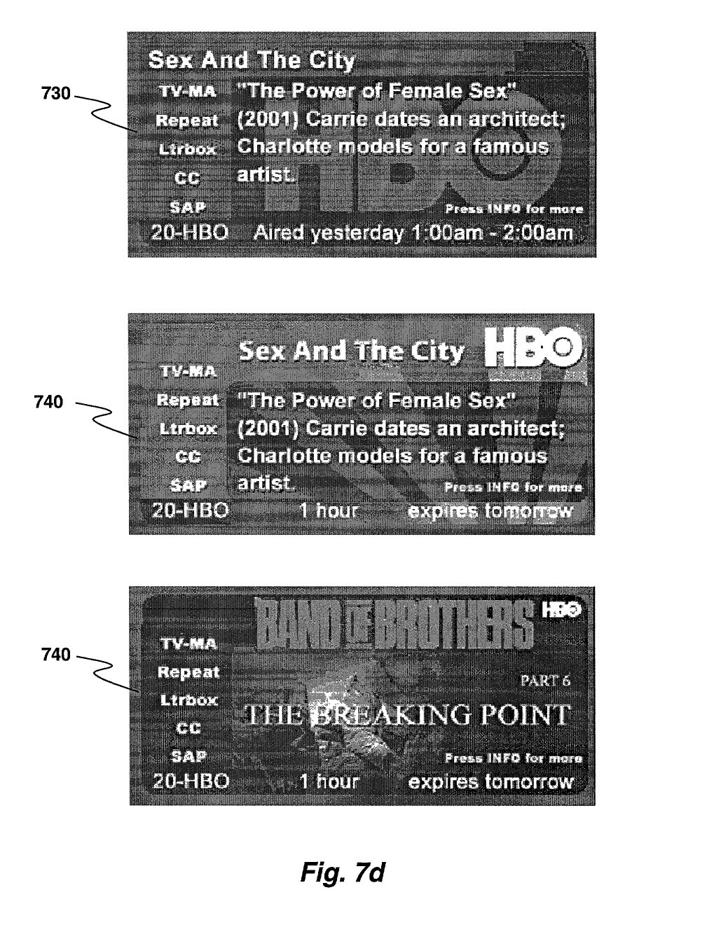

Additional embodiments of the graphical information region 410 will now be described with respect to FIGS. 7a-7d. As illustrated in FIG. 7a, one embodiment of the information region 700 is comprised generally of a title area 710, a flag area 712, a description area 714, and a status area 716. A corresponding information region 701 containing actual data is also illustrated.

In one embodiment, the title area 710 contains a character string listing the full title of the highlighted multimedia content. This may include the program title (e.g., NYPD Blue) and/or the episode title, depending on the embodiment. If the episode title is not included it may be included in the description area 714 (as mentioned below).

The flag area 712 of one embodiment contains glyphs for key information. The information may include TV/Movie rating (e.g., TV-MA for mature audiences, NR for no rating, R for restricted, . . . etc), an indication as to whether the playback should repeat, whether the program is letterboxed, whether closed captioning is available, whether the program is a pay-per-view or a subscription program, and/or an indication as to whether a second audio program (“SAP”) is available (e.g., in a different language).

The description area 714 contains a string of text providing a detailed description of the highlighted multimedia content. Various types of information may be provided including, but not limited to, the episode title (e.g., in quotes), the production year (e.g., in parentheses), and a description of the episode. In addition, in one embodiment, text for additional flags may be provided (e.g., in parentheses), including an indication of a season premiere, season finale, premiere, finale, animated program, live event, . . . etc.

In one embodiment, the status line 716 contains meta-information related to the multimedia content itself. This may be thought of generally as a mid-way point between the type of data in the flag area 712, and the type of data in the description area 714. The type of information provided in the status line 716 changes depending on the type of multimedia highlighted (e.g., recorded audio, recorded video, live TV, . . . etc), and/or the time that the multimedia content is scheduled to be broadcast/recorded. In the specific information region 701 illustrated in FIG. 7a, the status line 716 indicates that the highlighted program is a live broadcast program on Channel 14-KBWB which “Airs Tomorrow at 1:00 AM-2:00 PM.” Alternatively, if the program aired “yesterday,” this indication would appear in the status line. The status line may also provide the date on which the program airs/aired (e.g., if not yesterday, today or tomorrow) and/or the number of days before/after the program airs/aired. For a recorded show, the status line may indicate the channel, the length of time of the program (e.g., 1 hour) and an indication of when the recording expires (i.e., when the space occupied by the recording will be freed up for other multimedia content). As described above, by selecting the command menu, a user may modify the expiration date of the recording.

In one embodiment, a user may select an “info” button on the remote control device (or other input device) to obtain more information about a particular listing. An exemplary full screen information region which may be generated in response is illustrated in FIG. 7b through which the user may browse an additional description and credits for a particular program.

FIG. 7c illustrates an exemplary information region for a CD or album. The region includes a graphical image of the CD/album cover 720, an indication of the title 724 and a status bar 722 containing the number of tracks/minutes for the CD and the type of medium from which the audio content is being read. For example, “recorded” indicates that the CD is recorded on the mass storage device 330; “in tray” indicates that the CD is being rendered directly from the CD medium itself; “offline” indicates that the track or CD is not on the system (e.g., in search results or in an album completion feature where the user has only one track from an album, but the media browser shows the rest of the tracks from that album in an offline state); and “on player” indicates that the track or CD is located on an external device such as an MP3 device connected to the system.

As described above, content providers may choose to generate their own graphical information regions to visually differentiate their network or multimedia content. FIG. 6d illustrates three content-provider-specific information regions. Information region 730 is comprised of a layout where the underlying information is unchanged, but the background changes (i.e., displaying HBO in this case). Information region 740 shows significantly more content provider customization. The flag area and status area are fixed in the same location but the standard title field is replaced by a show title graphic. In addition, a graphic image fills the background of the entire region 740. Information region 750 illustrates a graphic used for an individual event, episode, or movie. All descriptive information is a graphic (rather than a field) to give the most customization to look and feel. A virtually unlimited number of alternative graphics and graphical animations may be employed while still complying with the underlying principles of the invention.

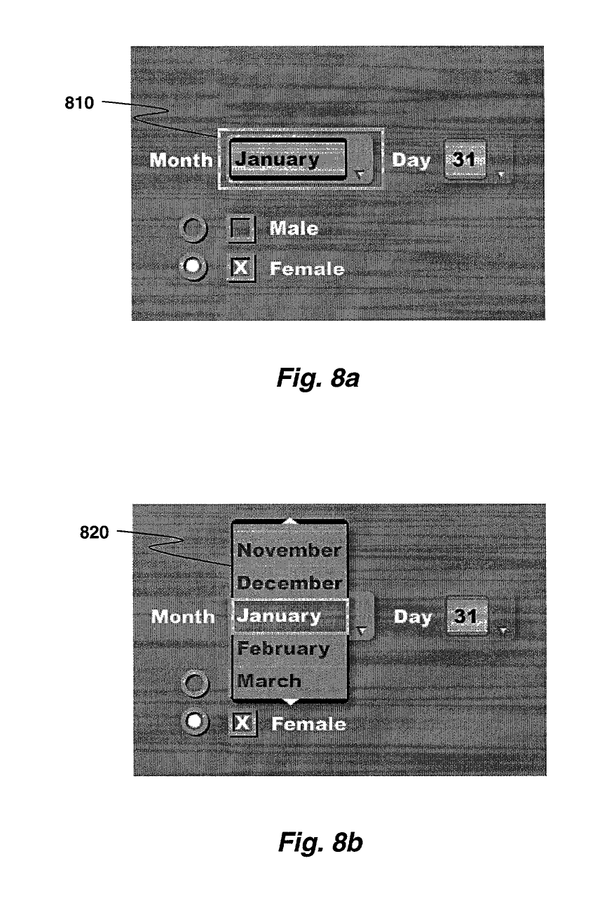

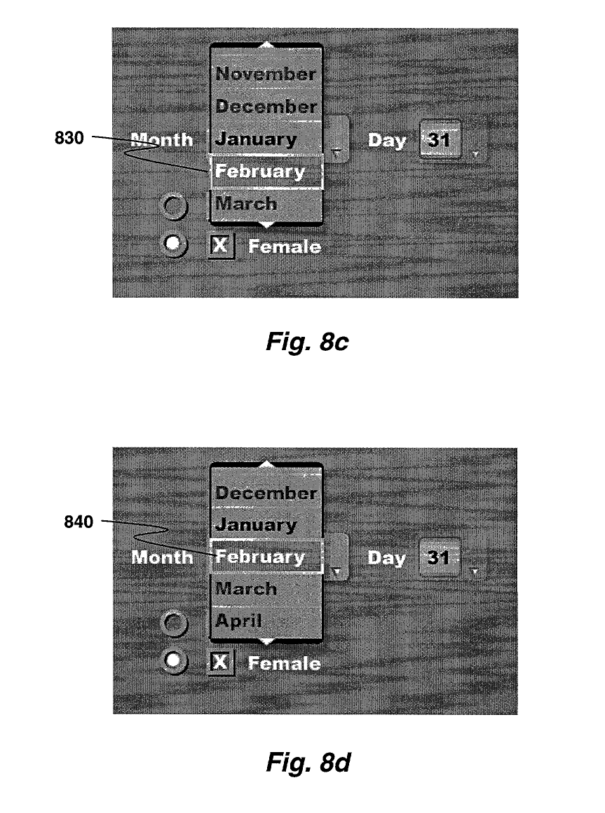

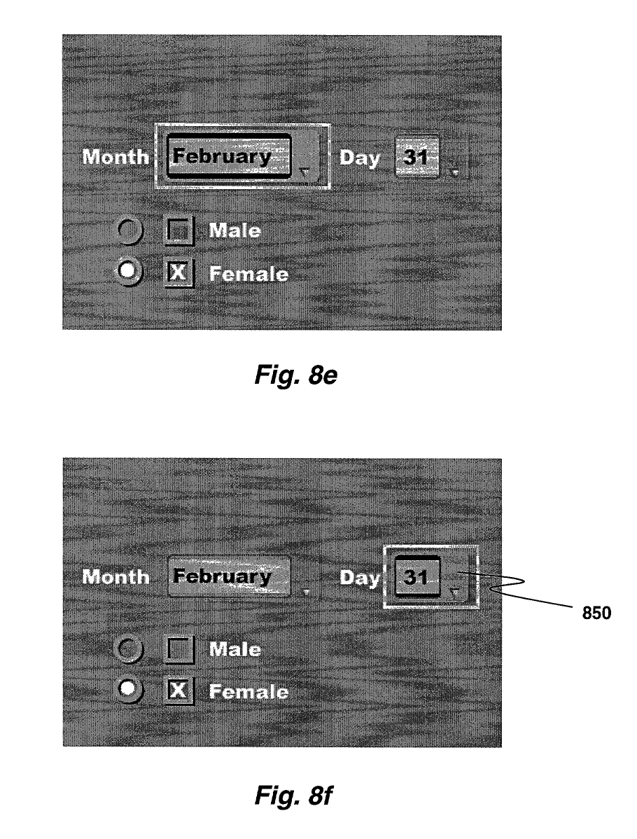

Users may frequently need to select data from a list within the graphical navigation interface (e.g., to select a particular recording date). One particular type of selection element or “widget” will now described with respect to FIGS. 8a through 8f. As illustrated in FIG. 8a, a selection element 810 indicates that the widget has been selected. The widget may initially be selected by the user via the direction keys on the remote control. Alternatively, the widget may be automatically selected based on the state of the system (e.g., when it is time to enter a date/time for a recording). In one embodiment, when selected, the color of the widget body may become brighter than it's surrounding widgets. This may be accomplished, for example, by adjusting the opacity of the widget body.

When the user presses “select” on the widget, the selection element changes its focus and highlights the contents of the list. In one embodiment, the user does not need to press a select key. Rather, after the selection element has been over the widget for a predetermined period of time (i.e., if the user does nothing), the “select” command will automatically be generated.

FIG. 8b illustrates an active widget list which obscures all other widgets on screen. In one embodiment, if the user were to press LEFT or RIGHT on the remote at this point they would be returned to the screen shown in FIG. 8a. As the user presses UP or DOWN, as shown in FIG. 8c, the selection element 810 along with the color-inverting box moves to select the next item 830 in the list. In one embodiment, the list of items may wrap around (i.e., so that only a portion is displayed at any given time). As illustrated in FIG. 8d, once the user stops moving the arrow keys UP or DOWN, the list, the selection element 810, and the color inverting box returns slowly to its natural position 840 where the highlighted list item is directly over the widget body. When the user presses SELECT, the value of the list item changes and returns to the state shown in FIG. 8e with the new value. The selection element 810 returns to selecting the widget. When the yellow highlight is moved to another widget 850 as shown in FIG. 8f, the body of the previous widget is dimmed.

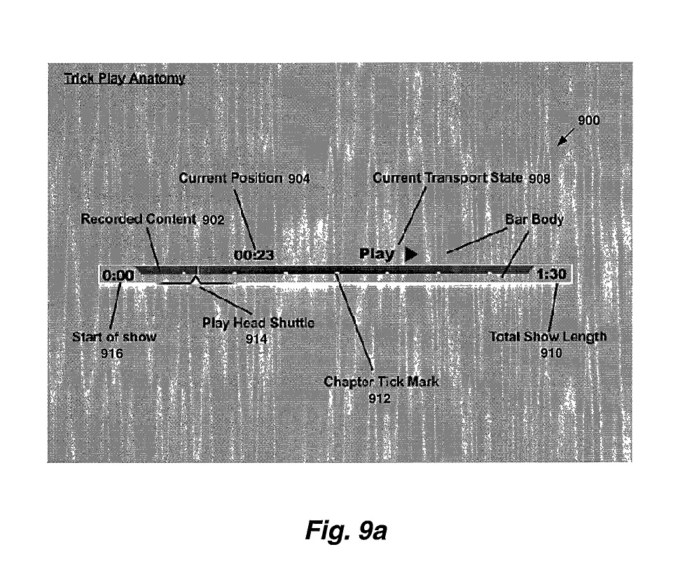

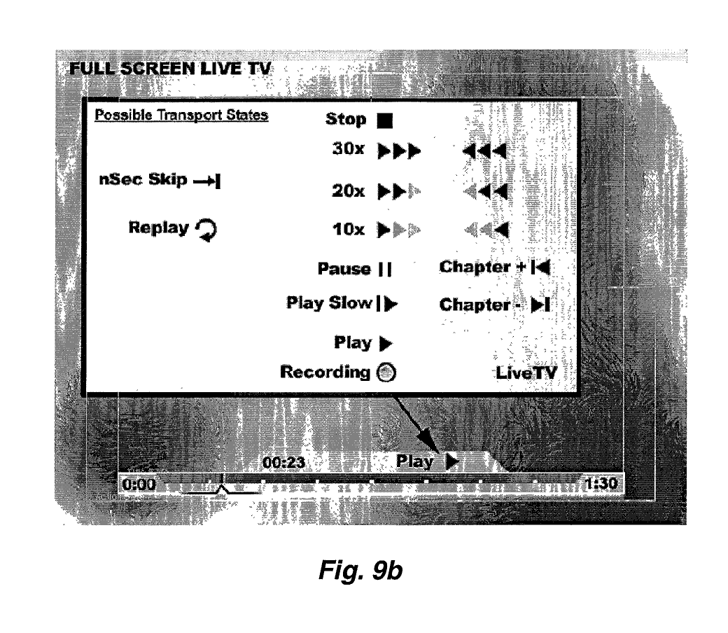

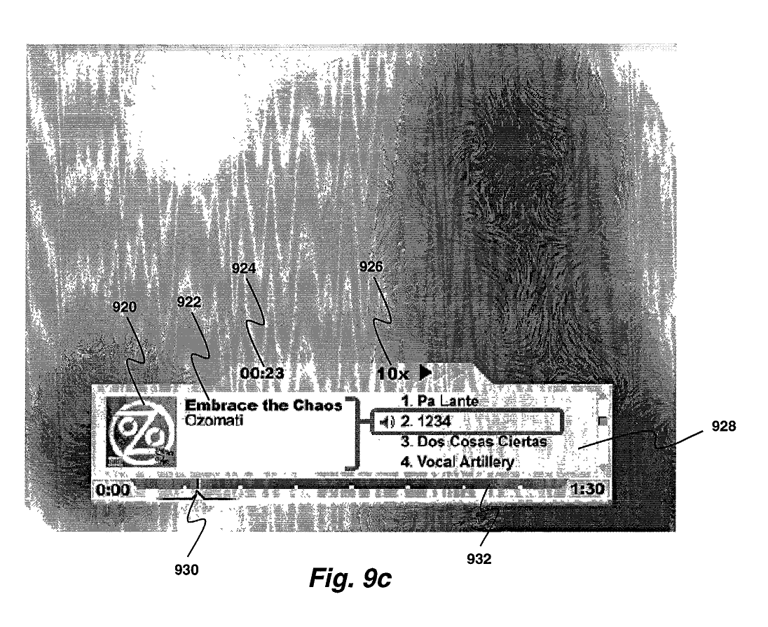

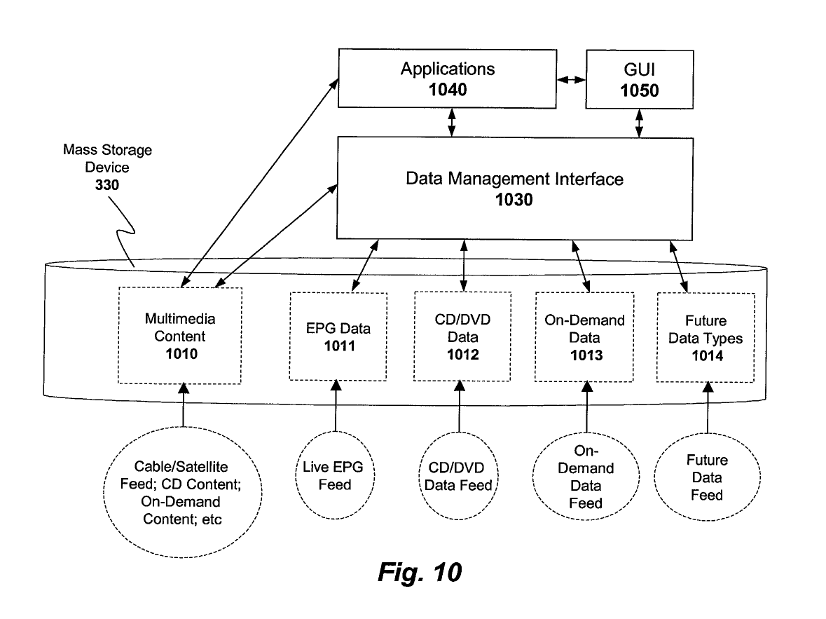

FIG. 9a illustrates a playback widget 900 employed in one embodiment of the invention. The playback widget (also referred to as the “trick mode” widget) includes an indication of recorded content 902 showing how much of the multimedia content is stored on the mass storage device 330. For example, as the broadcast of a particular television program progresses, the recorded content indicator 902 will fill in from the left to the right. The specific recorded content indicator 902 shown in FIG. 9b indicates a fully recorded program. A play head shuttle 914 indicates the point at which playback of the multimedia content is occurring. If the user is watching the particular television show mentioned above, the play head shuttle 914 and the recorded content indicator 902 will be at the same point. Alternatively, if the user is watching a delayed version of the program (e.g., because the user paused playback or started watching after the program started) the play head shuttle will lag behind the recorded content indicator 902 by the amount of the delay.

A start time indicator 916 and an end time indicator 910 indicate start time and end time, respectively. For a fully recorded show (as illustrated) the start time indicator shows 0:00 and the end time indicator 910 shows the length of the program. A current position indicator shows how far into the multimedia content playback has progressed (e.g., measured in time) and a current transport state indicator 908 shows the playback state (e.g., Fast Forward, Paused, Play, Rewind, . . . etc). A variety of different transport state indicators are illustrated in FIG. 9b. One or more chapter tick marks 912 show logical break points within the multimedia content (e.g., such as track borders within a DVD or a CD).

In one embodiment, the playback widget 900 appears when the user presses any of the transport controls (e.g., Play, Pause, Rewind, Fast Forward, Stop, Chapter + or −, Record, Instant Replay, Commercial Skip). The widget may disappear automatically after a period of time and/or when the user presses CLEAR on the remote control.

Another embodiment of a playback widget is illustrated in FIG. 9c. In addition to a playback head shuttle 930 and a recorded content indicator 932, this embodiment shows an image of a CD cover 920 and the CD title 922 on the left and a list of CD tracks 928 on the right. The transport indicator 926 shows that the user is fast-forwarding through the audio content on the CD.

As previously mentioned, embodiments of the digital media server 210 are capable of simultaneously supporting a wide variety of information and application types. In addition, text displayed on TVs (or other display devices) has to be fairly large in order to be readable at typical TV resolutions and viewing distances. These factors put screen real estate at a premium. In order to simultaneously manage the information with the constraints of TV display text string lengths have to be kept at a minimum. In one embodiment, the following additional technologies/features provide several means of dealing with shortened/concatenated text strings. In one embodiment, these features are implementing using a vector-based graphics software such as Macromedia® Flash.™ However, various alternate software (and hardware) packages may be employed while still complying with the underlying principles of the invention.

Marquee solution. A long text string or label (e.g., “The Night the Lights Went out in Georgia”) may be concatenated to the “The Night Ligh.” In the marquee solution, once the user moves the highlight over the item and leaves the cursor on the item for 1-3 seconds, the text begins to scroll so that the user can see the entire name.

Expandable highlight solution. Once the user moves the highlight over the item and leaves the cursor on the item for 1-3 seconds, the item expands vertically and/or horizontally to a size sufficient to display the entire string, or a much larger section of it.

Hover box solution. Once the user moves the highlight over the item and leaves the cursor on the item for 1-3 seconds, a box of sufficient size to contain the entire string appears just above the selected item.

### An Interface and Method for Managing Multimedia Content and Related Information

As described above, the digital media server 210 may be capable of processing various unrelated, normally incompatible types of multimedia content and data. For example, in one embodiment, the digital media server 210 processes and stores cable/satellite broadcast content and associated programming data (e.g., EPG data), CD audio content and associated CD data (e.g., album titles, track data), and various types of Internet-related content (e.g., e-commerce transaction data, Web pages, email data, chat room data and/or on-demand streaming media).

Thus, as illustrated in FIG. 10, in one embodiment of the invention, a generic data management interface 1030 is provided through which applications 1040, including the graphical user interface (“GUI”) 1050 described in detail above, access the various types of data and multimedia content. As indicated, this may include, but is not limited to electronic program guide (“EPG”) data 1011 transmitted over a live EPG feed, CD/DVD data 1012 retrieved from the Internet or directly from a CD/DVD database (e.g., such as the CDDB/Gracenote CD database), on-demand/Internet data 1013, and/or the underlying multimedia content itself 1010 (e.g., recorded video programs and CD audio content). In addition, as will be described in detail below, one embodiment of the data management interface 1030 is readily adaptable to future types of data/content 1014.

### Nodes

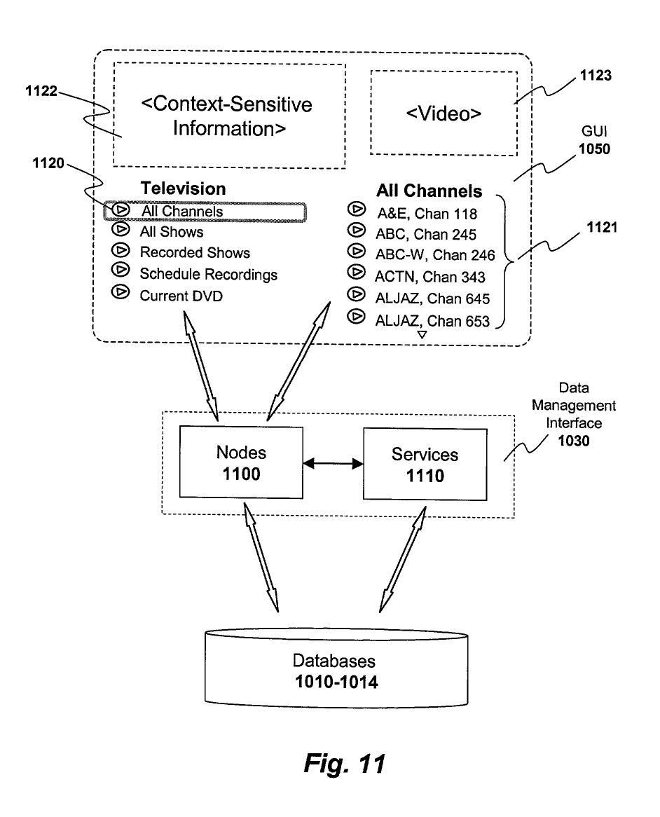

As illustrated in FIG. 11, one embodiment of the data management interface 1030 is comprised of two types of data objects, referred to herein as nodes 1100 and services 1110, respectively. Nodes 1100 are generic data interfaces between the databases 1010-1014 and the GUI 1050 and other applications 1050. Services 1110 provide actions which may be performed on nodes. Services 1110 will be described in detail below.

Nodes 1100 gather data from the various incompatible media databases 1010-1014 and store the data in memory in a generic manner which the GUI 1050 and other applications 1050 can interpret through a uniform interface of function calls. Each of the nodes 1100 may be programmed to reference a specific set of database 1010-1014 attributes in a consistent manner (e.g., a single identified row of an SQL data table). In one embodiment, the nodes 1100 are C++ objects; however, the underlying principles of the invention are not limited to any particular programming language.

As illustrated in FIG. 11, the GUI 1050 populates itself with data provided by a relevant set of nodes (e.g., “EPG” nodes, CD database nodes, . . . etc). In one embodiment, each of the individual menu items generated by the GUI 1050, such as the “All Channels” menu item 1120, is represented by a single node. In addition, in the particular GUI 1050 illustrated in FIG. 11, when a user selects a particular menu item 1120 from the menu, the node associated with that menu item identifies the series of nodes containing data for each of the submenu items 1121 (i.e., in this case, each of the broadcast channels supported by the system). Once generated, the data from each of the nodes is displayed within the GUI 1050 as shown. As used herein, the highlighted menu item 1120 will be referred to as a “parent” and the sub-menu items 1121 will be referred to as “children” of the parent menu item 1120. Thus, in addition to providing the data to be displayed within the GUI 1050, each node also contains data linking the menu hierarchy together in a logical manner.

In addition to providing data for the menu hierarchy, each node may also contain data to be displayed within the various fields of the information region 1122 of the GUI 1050. This may include information for the title area 710, the flag area 712, the description area 714, and/or the status area 716 (described in detail above). Once again, the data may be retrieved by the nodes from the various databases 1010-1014 and provided to the GUI in a consistent manner. Thus, data retrieved from the CD database 1022 (e.g., album cover, album title, track titles, etc) is formatted and provided to the GUI using the same function calls (i.e., via the same API) as information retrieved from the EPG database 1011.

Nodes may also identify graphical content to be used to display and define layout within the informative region 1122 or the menu item region 1120 or the region of sub-menu items 1121. The Nodes knows which graphical asset should be used; but have no dependency on the layout of text within that graphical asset. For example, a Node for a particular content provider (such as the HBO Node 1232 described below) may specify branded HBO graphics to populate the regions.

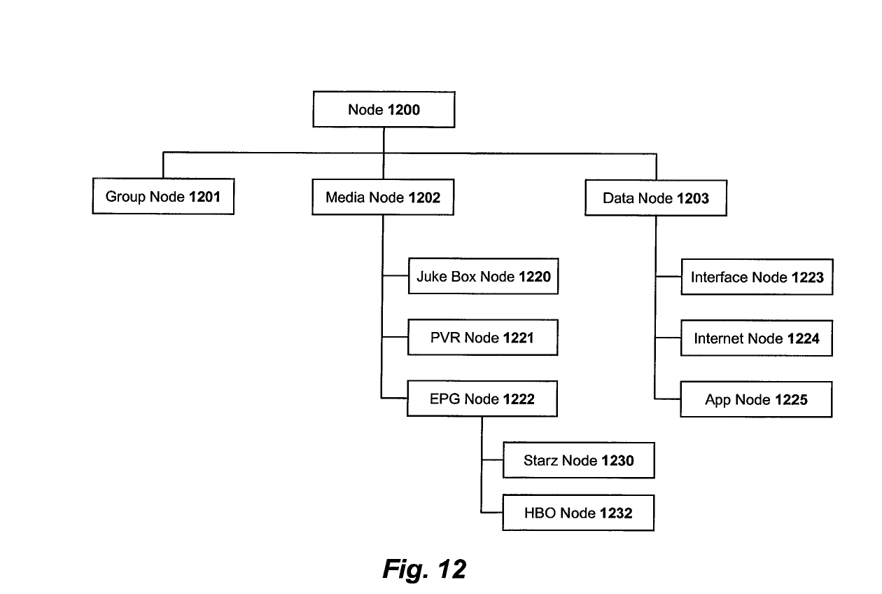

The concept of “inheritance” is well known in object-oriented programming. In one embodiment of the invention, a generic node class is defined which contains a basic set of functions inherited by all other nodes (i.e., nodes derived from the basic node template). Thus, through inheritance, all derived nodes inherit the basic functionality of the generic node class. This concept is graphically illustrated in FIG. 12 which shows a set of three exemplary nodes, a Group Node 1201, a Media Node 1202 and a Data Node 1203, which are derived from the basic Node class 1200.

The group Node 1201 employed in one embodiment of the invention exists solely as a collection of other nodes. The Media Node 1202 generally contains attributes for various stored multimedia types which may be played or recorded or downloaded. The Data Node 1203 represents data that affects the GUI by either defining a menu or launching a widget (Internet Node 1224) or application (App Node 1225). A juke Box Node 1220 in one embodiment represents a single element from a music database, be it an album, artist or track. The PVR Node 1221 and EPG Node 1222 are close siblings in that they both represent data for a television program. The PVR Node differs from the EPG Node only in that the program has been scheduled for record/download, so is or will be available for viewing off of storage. An Interface Node 1223 is used to represent menu sub-hierarchy. An Internet Node 1224 is a link to a web site, and an App Node 1225 launches an application component.

More specific nodes, a Starz Node 1230 and an HBO node 1232, are generated based on the EPG Node 1222. The Starz Node 1230 and HBO Node 1232 are examples of the granularity of control that maybe achieved through Node types. An HBO Node 1232 (or any node from a content provider) inherits all of the attributes of an EPG Node 1222, such as a station, scheduled air date, and program information; but could also provide layout information unique to HBO content as mentioned above. The HBO Node 1232 might override the default behavior of EPG Node 1222 and specify HBO branded graphical assets for the different regions of the screen. Thus, if a content provider such as HBO wishes to generate its own unique audio, video, graphics or text when a user selects the content provider's menu item (e.g., to visually differentiate their service or content), the provider can do so by creating its own specific node type containing the fundamental characteristics of the EPG Node 1222 structure as well as it's own specific characteristics.

Likewise, an HBO Service (services are described in detail below) could provide specific actions to the HBO Node. For example, in addition to offering to record the program, as a standard EPG Service might do, the HBO Service might provide actions tying in with additional commerce opportunities. Both the HBO Node and HBO Service might also be configured to collect focused backhaul information (e.g., collecting aggregate data of HBO viewership). Several exemplary functions provided via the basic Node class 1200 are set forth below.

### Services

In one embodiment, nodes themselves are unaware of the operations that may be performed on them or associated with them (e.g., such as those described above with respect to the action menus shown in FIGS. 6a-6e). Rather, these actions are provided via separate and independent functional modules referred to herein as “services.”

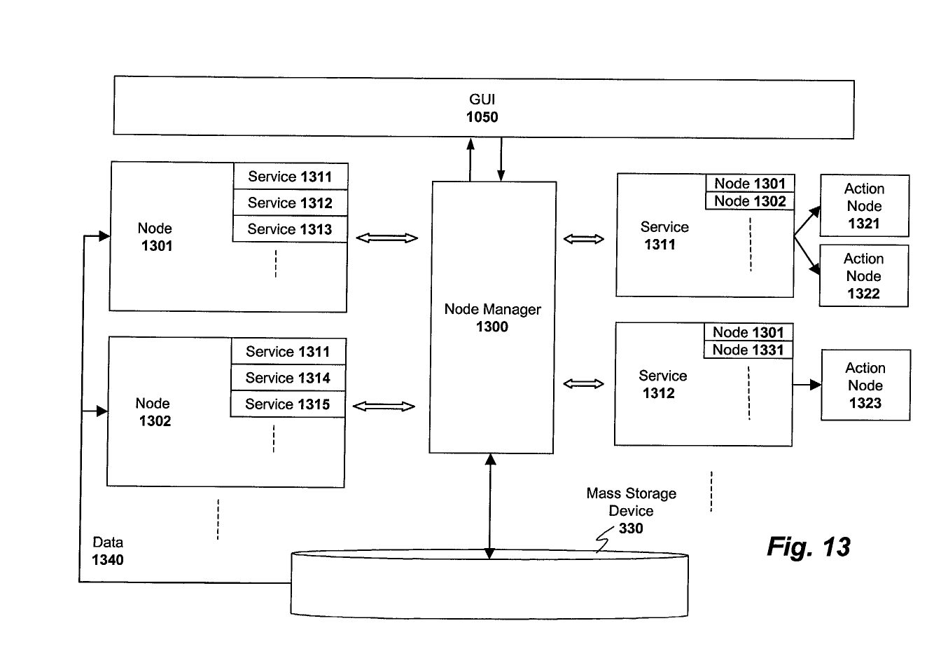

As illustrated in FIG. 13, in one embodiment, each node may have several services associated with it and each service may be associated with several different nodes. Services 1311 through 1313 associate with Node 1301. Similarly, Service 1312 is associated with Node 1301 and Node 1331 (not shown). In the illustrated embodiment, the loading of Nodes 1301, 1302 and their associated Services 1311, 1312 is performed by a central in-memory module referred to as a Node Manager 1300. In operation, when the GUI 1050 or other application 1040 requests a Node, the Node Manager 1300 returns the Node to the caller and attaches the appropriate service(s) to the Node for action call-through (described below). In one embodiment, each service is a singleton. If multiple nodes use the same service, they all reference the same in-memory object.

In one embodiment, when the GUI 1050 or other application 1040 requests a list of services associated with a node (e.g., via the GetActions( ) method mentioned below), each associated service 1311, 1312 generates an Action Node 1321, 1322, 1323. The service provides keys to its actions within each Action Node 1321, 1322, 1323 which point directly back to member functions within the service that performs the actions. That is, with the key and the node to act upon, the Action Node 1321, 1322 calls into the recipient's service to trigger the requested action.

By having Action Nodes in one embodiment of the invention, the GUI can handle them in the same way it handles any other Node. Action Nodes provide the same function calls as the default Node, and can therefore populate the Info Region and menu list with descriptive text.

The keys given to action nodes by the services are constant. It is possible that part of the GUI could create an Action Node, assign it a known key, and pass it to a service without ever calling GetActions( ). Since the Service is given the Action Node with a key, if the service doesn't handle the key it could ignore the action node. Or, similarly, different services could handle the same key differently; so passing the same Action Node to different services may create different behavior. For example, passing an Action Node with a ‘RecordNow’ key in it plus an EPG Node to the standard EPG Service could trigger a recording; but passing the same Action Node and the same EPG Node to a special Pay Per View Service could trigger the recording and a commerce action. Each Service decides what to do with the key, based upon the Node its given. The Action Node is the conveyor for triggering the action, plus the element which puts information into the GUI.

With the key system and because they are just another type of Node, Action Nodes may be placed in the GUI as a menu item. In one embodiment, this is how the list of action menu items is generated within the GUI for a user to choose from. In addition, in one embodiment, an Action Node may be placed inline with other Nodes, such that it activates when the user selects it in the GUI.

Separating nodes (containing the underlying data) from services (containing operations related to the data) in this manner provides for a significantly improved system architecture. For example, individual services may be added (i.e., “plugged in”), modified or removed without affecting the entire system. For example, if a new audio editing service is developed, it may be incorporated into the system seamlessly, without affecting any of the nodes with which it is associated or any of the other services. The new service will be linked to a group of nodes via the Node Manager 1300 and will subsequently appear in action menus associated with the nodes it services (e.g., all of the nodes associated with audio content).

In one embodiment, Services, their actions, and Nodes can be varied in the runtime environment based upon active applications and features on the running platform (e.g., the digital media server). They may also be used to enable features such as remote commerce and security. Nodes are always referred to via a constant “Identity” and version. When entities like widgets or Services request a particular Node's Identity, the Node Manager links the identity to the matching Node library. The Node library may be loaded off of the local platform (e.g., from the digital media server's mass storage device) and/or may be downloaded on the fly from a network. An additional layer of verification of the Node library may be applied before linking it to the requested identity. Likewise, if unable to link the expected Node Library with the requested Identity, the Node Manager may choose to link the Identity with a different, default, library. Since the widgets and GUI handle Nodes uniformly, they need not know a different Node type was returned.

Similar behavior may exist for a Service. Special services may exist in a remote networked environment. Based upon the platform's security verification and enabled features, it may connect to use those services and their actions.

In sum, Nodes and services may change during the runtime, and do not even necessarily need to live locally on the platform. For example, there could be an Internet Service that is located on a service, and only provides actions if the platform is networked, and is therefore able to connect to it.

In one embodiment of the invention, the basic Node class 1200 mentioned above contains, but is not limited to, the following set of calls which are made accessible to the GUI 1050 and other applications 1040:

GetlnfoBoxData( )—Fills data for the information region 1122

GetListItemData( )—Fills data for the menu item 1120 in the list.

GetChildrenData( )—Identifies what widget and/or movie should contain the children of this node.

GetName( )—Returns a string of the node's “name” or “title.”

GetActions( )—Returns an array of ActionNodes that are the actions that may be performed on the node. In one embodiment, this passes directly to the GetActions of its connected Node Service. The concept of Node Services is described in detail above.

GetChildren( )—Returns an array of Nodes that follow this node in the menu hierarchy. Takes parameters of which index, how many to return and whether to filter the children based upon the filter string.

GetChildrenSearchStrings( )—As quickly as possible, returns strings representing the names of all children nodes. In one embodiment, this is used for search indexing, and may vary from the string returned by GetName( ).

NChildren( )—Returns the number of children nodes associated with the node.

SetAttributeData( )—Takes a string or raw data which may be used to set anything in the Node. Each node may be configured to handle this call differently.

In one embodiment, through inheritance, each method of the base Node may be overridden with an internal implementation by a different Node type. Each Node also contains the method CastNode( ) which can be used to attempt to convert a base Node to one of its inherited types. This may be used on occasions when a generic Node needs to be handled as a specific Node type.

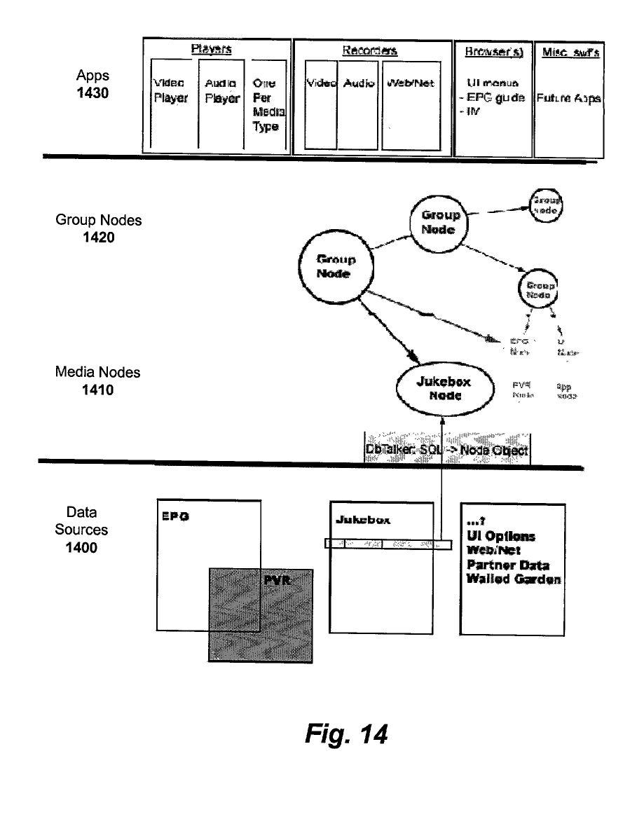

A layered architecture according to one embodiment of the invention is further illustrated FIG. 14. As shown, data from various disparate data sources 1400 is retrieved and stored on the system to be used by different applications 1430 (e.g., the graphical navigation system described above). In between the applications 1430 and the data sources 1400 are two distinct node/service layers: a layer of Group Nodes 1420 and a layer of Media Nodes 1410. The Media Nodes 1410 reference the underlying data on disk (e.g., by referencing a specified set of database attributes, based on the particular database and the particular data needed). In one embodiment, this is accomplished via a DB Talker interface module 1415 which converts the Media Node database queries into standard database queries (e.g., using the structured query language (“SQL”) or other database language).

Embodiments of the present invention include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the present system and method. It will be apparent, however, to one skilled in the art that the system and method may be practiced without some of these specific details. For example, while many of the embodiments above focus on a GUI implementation, the underlying principles of the invention may be employed in virtually any data processing environment. Accordingly, the scope and spirit of the invention should be judged in terms of the claims which follow.

[image]

[image]

What is claimed is:

1. A graphical user interface (“GUI”) for navigating through multimedia content comprising:
a left menu region comprising a first plurality of selectable menu elements, one or more of said first plurality of selectable menu elements having a plurality of sub-elements associated therewith;
a selection element to identify one of said first plurality of selectable menu elements; and
a right menu region adjacent to said left menu region, said right menu region to display a first plurality of sub-elements associated with an identified one of said first plurality of selectable menu elements.

2. The GUI as in claim 1 wherein said selection element moves up and down to identify one of said first plurality of selectable menu elements responsive to user input.

3. The GUI as in claim 2 wherein said selection element moves to the right to identify a sub-element from said first plurality of sub-elements responsive to user input.

4. The GUI as in claim 3 wherein once said selection element identifies a sub-element from said first plurality of sub-elements, said first plurality of sub-elements shifts to the left and a second plurality of sub-elements associated with an identified one of said first plurality of sub-elements appears to the right relative to said first plurality of sub-elements.

5. The GUI as in claim 3 wherein said selection element selects one of said first plurality of selectable menu elements or one of said first plurality of selectable sub-elements responsive to a user choosing a “select” key on a remote control or other input device.

6. The GUI as in claim 4 wherein said second plurality of sub-elements shifts on screen from the right.

7. The GUI as in claim 4 wherein said selection element shifts to the left with said first plurality of sub-elements.

8. The GUI as in claim 1 wherein said first plurality of selectable menu elements comprises a channel listing and wherein said first plurality of sub-elements comprises a listing of times at which programs are broadcast on an identified one of said channels.

9. The GUI as in claim 1 further comprising a graphical information region for displaying information related said identified one of said first plurality of selectable menu elements.

10. The GUI as in claim 9 wherein said identified one of said first plurality of selectable menu elements comprises a television program and wherein said graphical information comprises a program title and a program description.

11. The GUI as in claim 10 wherein said graphical information further comprises a program rating and a listing of actors in said program.

12. The GUI as in claim 9 further comprising:
a video region for displaying video of a current broadcast or recorded program.

13. The GUI as in claim 1 further comprising:
a command menu generated responsive to a user input, said command menu containing a list of actions associated with said identified one of said first plurality of selectable menu elements.

14. The GUI as in claim 13 wherein said identified one of said first plurality of selectable menu elements represents broadcast multimedia content and two of said actions are Play, to play said broadcast multimedia content in real time, and Play From Start, to play said broadcast multimedia content from the beginning.

15. The GUI as in claim 13 wherein said identified one of said first plurality of selectable menu elements represents broadcast multimedia content and one of said actions is Change Expiration to change a time and date on which said broadcast multimedia content will be erased.

16. The GUI as in claim 13 wherein said identified one of said first plurality of selectable menu elements represents broadcast multimedia content and one of said actions is Record to record said broadcast multimedia content.

17. A graphical user interface (“GUI”) for selecting multimedia content comprising:
a first menu region comprising a first plurality of selectable menu elements, one or more of said first plurality of selectable menu elements having a plurality of sub-elements associated therewith;
a selection element to identify one of said first plurality of selectable menu elements;
a second menu region adjacent to said first menu region, said second menu region to display a first plurality of sub-elements associated with an identified one of said first plurality of selectable menu elements; and
an information region adjacent to either said first or second menu regions, said information region containing information related to said identified one of said first plurality of selectable menu elements.

18. The GUI as in claim 17 further comprising:
a video region for displaying video of a current broadcast or recorded program.

19. The GUI as in claim 16 wherein said selection element moves up and down to identify one of said first plurality of selectable menu elements responsive to user input.

20. The GUI as in claim 18 wherein said selection element moves to the right to identify a sub-element from said first plurality of sub-elements responsive to user input.

21. The GUI as in claim 19 wherein once said selection element identifies a sub-element from said first plurality of sub-elements, said first plurality of sub-elements shifts to an area previously occupied by said first plurality of selectable menu elements and a second plurality of sub-elements associated with an identified one of said first plurality of sub-elements shifts to an area previously occupied by said first plurality of sub-elements.

22. The GUI as in claim 19 wherein said selection element selects one of said first plurality of selectable menu elements or one of said first plurality of selectable sub-elements responsive to a user choosing a “select” key on a remote control or other input device.

23. The GUI as in claim 20 wherein said second plurality of sub-elements shifts on screen from the right.

24. The GUI as in claim 17 wherein said first plurality of selectable menu elements comprises a channel listing and wherein said first plurality of sub-elements comprises a listing of times at which programs are broadcast on an identified one of said channels.

25. The GUI as in claim 17 wherein said identified one of said first plurality of selectable menu elements comprises a television program and wherein said information comprises a program title and a program description.

26. The GUI as in claim 25 wherein said information further comprises a program rating and a listing of actors in said program.

27. The GUI as in claim 17 further comprising:
a command menu generated responsive to a user input, said command menu containing a list of actions associated with said identified one of said first plurality of selectable menu elements.

28. The GUI as in claim 27 wherein said identified one of said first plurality of selectable menu elements represents broadcast multimedia content and two of said actions are Play, to play said broadcast multimedia content in real time, and Play From Start, to play said broadcast multimedia content from the beginning.

29. The GUI as in claim 27 wherein said identified one of said first plurality of selectable menu elements represents broadcast multimedia content and one of said actions is Change Expiration to change a time and date on which said broadcast multimedia content will be erased.

30. The GUI as in claim 27 wherein said identified one of said first plurality of selectable menu elements represents broadcast multimedia content and one of said actions is Record to record said broadcast multimedia content.

31. A multimedia playback widget comprising:
a recorded content indicator graphically indicating an amount of broadcast multimedia content stored on a mass storage device; and
a playback shuttle indicator graphically indicating a point within said broadcast multimedia content at which playback is occurring.

32. The multimedia playback widget as in claim 31 further comprising:
a start time indicator indicating a start time of said multimedia content and an end time indicator indicating an end time of said multimedia content.

33. The multimedia playback widget as in claim 32 further comprising:
a playback progress indicator displaying time associated with said point within said broadcast multimedia content at which playback is occurring.

34. The multimedia playback widget as in claim 32 further comprising:
a current transport state indicator indicating a current transport state of said multimedia content.

35. The multimedia playback widget as in claim 31 wherein said recorded content indicator and said playback shuttle indicator are visually offset from one another by an amount equal to a delay in time between when said broadcast multimedia content is received and played back, respectively.
